(19) United States
(12) Patent Application Publication
(10) Pub. No.: US 2006/0253400 A1
(43) Pub. Date: Nov. 9, 2006

(54) Digital content delivery system

(76) Inventors: Ryuichi Okamoto, Osaka (JP); Susumu Kobayashi, Kyoto (JP); Stefan Walter, Osaka (JP); Katsumi Tokuda, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/538,022

(22) PCT Filed: Mar. 4, 2004
(86) PCT No.: PCT/JP04/02716

§ 371 Date: Jun. 7, 2005

(30) Foreign Application Priority Data
Mar. 5, 2003 (JP) 2003-058351

(51) Int. Cl. G06Q 99/00

(52) U.S. Cl. 705/57; 705/51

(57) ABSTRACT

A digital content distribution system (1) is composed of a right management server (100) and a user terminal (110) which are connected via a transmission line (120). The right management server (100) is made up of: a license data generating unit (304) which issues license data (usage right information) (1700) indicating a usage rule of content that is a digital copyrighted work to the user terminal (110); and an access condition setting unit (305) which notifies the user terminal (110) of update information (access condition) regarding necessity of updating the license data (1700) issued to the user terminal (110). The user terminal (110) is made up of: a content DB (701) which stores content; a license data DB (702) which stores the license data (1700) issued by the license data generating unit (304); a content reproducing unit (710) which uses the content stored in the content DB (701) in accordance with the usage rule indicated by the license data (1700) stored in the license data DB (702); and a license data upgrading unit (706) which requests the right management server (100) to update the license data (1700) stored in the license data DB (702) in accordance with the access condition notified by the access condition setting unit (305).

### TECHNICAL FIELD

The present invention relates to a digital content distribution system, particularly to a digital content distribution system which is able to protect a right related to digital content data.

### BACKGROUND ART

In recent years, systems which distribute digital copyrighted works, such as music, images, and games, using the Internet or digital broadcasting have been developed. Some of them have entered a commercial stage. In connection with the content distribution, methods of controlling content usage are considered to limit the number of reproduction times, transfers, and duplicates of the distributed content from the viewpoint of copyright protection.

In a case of a conventional digital content distribution system, a usage rule given to a user for using content is distributed to a user terminal together with the content. The user terminal manages the content usage in accordance with the distributed usage rule. (See Japanese Laid-Open Patent Application No. 2000-48076, for example.)

For example, if the user purchases a right to watch a movie titled “EIGA” three times, the user terminal receives the usage rule indicating that “the user can watch EIGA three times” as well as receiving the content of the movie “EIGA” from a distribution server. In accordance with this usage rule, the user terminal manages the content reproduction. Every time the user watches the content “EIGA”, the user terminal performs processing so as to reduce the allowed number of reproduction times by “1”. The allowed number of reproduction times is indicated by the usage rule ATTACHMENT managed by the user terminal. When the allowed number of reproduction times reaches “0”, the user terminal performs processing so as not to allow the movie to be watched.

However, there has been a problem in using the conventional technology. After a right management server distributes the usage rule to the user terminal, no methods are provided for accessing the right management server or for changing the usage rule of the content distributed to the user terminal even if a content provider wishes to change the usage rule.

To be more specific, suppose that the condition of the content “EIGA” was to reproduce in monaural sound while it was shown at the theaters and that the monaural sound is upgraded to stereo sound after the end of the showing at the theaters. In this case, a user who purchased a usage right while it was shown at the theaters has to watch the content “EIGA” in monaural sound in accordance with the reproduction condition even after the end of the showing at the theaters. In order to watch the content “EIGA” with the reproduction condition indicating stereo sound, the user has to newly purchase a right to watch the “EIGA” in stereo sound. As another example, even in a case where the allowed number of reproduction times of content “ONGAKU” is increased by three as a campaign or the like, the user cannot benefit from it and the same problem as is the case with the “EIGA” happens.

The present invention is conceived in view of such a situation, and a first object of the present invention is to provide a system which enables access to the right management server to be performed at the appropriate timing so that the usage rule distributed from the right management server to the user terminal is updated.

A second object of the present invention is to provide a system which enables an update of the usage rule to be performed at the appropriate timing.

### DISCLOSURE OF INVENTION

To achieve the above-stated first object, a digital content distribution system of the present invention is composed of a right management server and a user terminal which are connected via a transmission line, wherein the right management server includes: a usage right information issuing unit that issues usage right information indicating a usage rule of content which is a digital copyrighted work to the user terminal; and an update information notifying unit that notifies the user terminal of update information regarding necessity of updating the usage right information issued to the user terminal, and the user terminal includes: a content storing unit that stores the content; a usage right information storing unit that stores the usage right information issued by the usage right information issuing unit; a using unit that uses the content stored in the content storing unit in accordance with the usage rule indicated by the usage right information stored in the usage right information storing unit; and an update requesting unit that requests the right management server to update the usage right information stored in the usage right information storing unit, in accordance with the update information notified by the update information notifying unit.

With this structure, the user terminal can access the right management server at the appropriate timing to have the distributed usage rule updated.

According to the digital content distribution system of the present invention, the update information notifying unit may notify the user terminal of the update information by including the update information in the usage right information issued by the usage right information issuing unit.

With this structure, a complicated procedure to separately obtain the update information is unnecessary.

According to the digital content distribution system of the present invention, the update information may include information regarding a timing at which the user terminal should access the right management server, and the update requesting unit may access the right management server at the timing indicated by the update information and request the right management server to update the usage right information.

According to the digital content distribution system of the present invention, the update information may include information regarding a frequency at which the user terminal should access the right management server, and the update requesting unit may access the right management server at the frequency indicated by the update information and request the right management server to update the usage right information.

According to the digital content distribution system of the present invention, the update information may include a flag showing whether or not the user terminal should access the right management server, and the update requesting unit may access the right management server in accordance with the flag and request the right management server to update the usage right information.

According to the digital content distribution system of the present invention, the usage right information may include an identifier to identify itself, and the update information may include the identifier of the usage right information which is an object to be updated.

On account of the identifier, the usage right information to be updated is easily identified.

The digital content distribution system of the present invention may be composed of a plurality of user terminals, wherein the update information notifying unit may specify, for each user terminal, the usage right information which is the object to be updated among sets of the usage right information held by the user terminal, create the update information including the identifier of the specified usage right information, and notify the user terminal of the created update information.

With this structure, the update requesting unit of the user terminal can easily specify the usage right information which is the object to be updated, on the basis of the update information created specifically for the user terminal.

The digital content distribution system of the present invention may be composed of a plurality of user terminals, wherein the update information notifying unit may specify, for each user terminal, the usage right information which is the object to be updated among sets of the usage right information held by all of the plurality of user terminals, create the update information including the identifier of the specified usage right information, and notify the user terminal of the created update information.

This can save the right management server from having to create the update information specifically for each user terminal.

To achieve the above-stated second object, the digital content distribution system of the present invention may be composed of: the right management server further including an update data transmitting unit that transmits, to the user terminal, data for usage right information update that is used for updating the usage right information held by the user terminal to latest usage right information when receiving a request to update the usage right information from the user terminal; and the user terminal further including an updating unit that receives the data for usage right information update that is transmitted from the right management server, reads the usage right information corresponding to the received data for usage right information update from the usage right information storing unit, and updates the read usage right information, wherein the using unit uses the content stored in the content storing unit in accordance with the usage rule indicated by the updated usage right information.

With this structure, the usage rule distributed to the user terminal can be updated at the appropriate timing.

According to the digital content distribution system of the present invention, the usage right information may include an identifier to identify itself, the update requesting unit may request an update by notifying the right management server of the identifier of the usage right information which is to be an object of the update, and the update data transmitting unit may transmit, to the user terminal, the data for usage right information update that is used for updating the usage right information identified by the identifier notified by the update requesting unit to the latest usage right information.

On account of the identifier, the usage right information to be updated is easily identified.

According to the digital content distribution system of the present invention, the update requesting unit may further request the update by notifying the right management server of the usage rule of the usage right information together with the identifier of the usage right information.

According to the digital content distribution system of the present invention, the update requesting unit may request an update by transmitting the usage right information which is an object of the update to the right management server, and the update data transmitting unit may transmit, to the user terminal, the data for usage right information update that is used for updating the usage right information transmitted from the update requesting unit to the latest usage right information.

According to the digital content distribution system of the present invention, the usage right information may include an identifier to identify itself, the data for usage right information update may include the identifier of the usage right information which is an object to be updated and data indicating details of the update, and the updating unit may update the usage right information on the basis of the identifier and the data indicating the details of the update that are included in the data for usage right information update.

According to the digital content distribution system of the present invention, the usage right information may include an identifier to identify itself, the data for usage right information update may include the identifier of the usage right information which is an object to be updated and information indicating an updated usage rule, and the updating unit may read, from the usage right information storing unit, the usage right information identified by the identifier included in the data for usage right information update, and update the usage right information by replacing the usage rule of the read usage right information with the updated usage rule included in the data for usage right information update.

According to the digital content distribution system of the present invention, the data for usage right information update may include updated usage right information, and the updating unit may read, from the usage right information storing unit, the usage right information corresponding to the updated usage right information included in the data for usage right information update, and update the usage right information by replacing the read usage right information with the updated usage right information included in the data for usage right information update.

According to the digital content distribution system of the present invention, the usage right information may include an identifier to identify itself, the data for usage right information update may include the identifier of the usage right information which is an object to be updated and additional data which should be linked to the usage right information that is the object to be updated, and the updating unit may read, from the usage right information storing unit, the usage right information identified by the identifier included in the data for usage right information update, and update the usage right information by linking the additional data to the read usage right information.

According to the digital content distribution system of the present invention, the usage right information may include an identifier to identify itself, the data for usage right information update may include the identifier of the usage right information which is an object to be updated and additional license information indicating a usage rule to be added, and the updating unit may read, from the usage right information storing unit, the usage right information identified by the identifier included in the data for usage right information update, and update the usage right information by adding the usage rule indicated by the additional license information included in the data for usage right information update to the usage rule indicated by the read usage right information.

According to the digital content distribution system of the present invention, the usage right information issuing unit may affix a digital signature to the usage right information, and transmit the usage right information together with the obtained signature text to the user terminal, and the update data transmitting unit may affix a digital signature to the data for usage right information update, and transmit the data for usage right information update together with the obtained signature text to the user terminal.

According to the digital content distribution system of the present invention, the update requesting unit may obtain, from the right management server, data for usage right information update that is used for updating the usage right information stored in the usage right information storing unit when requesting the right management server for an update.

As described so far, according to the digital content distribution system of the present invention, the first effect can be achieved by the user terminal that can access the right management server at the appropriate timing in order to update the received license data. In addition, the second effect can be achieved by the right management server that can upgrade the license data transmitted to the user terminal at the appropriate timing.

It should be noted that the present invention can be realized not only as such a digital content distribution system, but also as: a right management server that makes up the digital content distribution system; a user terminal that makes up the digital content distribution system; a right management method and a content usage method which respectively have characteristic units provided for such a right management server and a user terminal as steps; and programs that cause computers to execute these steps. It should be understood that such programs can be distributed via a recording medium such as a CD-ROM or a transmission medium such as the Internet.

### BRIEF DESCRIPTION OF DRAWINGS

FIG. 1 is a block diagram showing an overall structure of a digital content distribution system in a first embodiment of the present invention.

FIG. 2 is a diagram showing a structure of content data 200 in the first embodiment of the present invention.

FIG. 3 is a block diagram showing a structure of a right management server 100 in the first embodiment of the present invention.

FIG. 4 is a diagram showing an example of a user information DB 300 in the first embodiment of the present invention.

FIG. 5 is a diagram showing an example of a structure of a usage right DB 301 in the first embodiment of the present invention.

FIG. 6 is a diagram showing a structure of license data 1700 in the first embodiment of the present invention.

FIG. 7 is a diagram showing a structure of a user terminal 110 in the first embodiment of the present invention.

FIG. 8 is a diagram showing a structure of a usage right purchase request 800 in the first embodiment of the present invention.

FIG. 9 is a diagram showing a structure of a license data upgrade request 900 in the first embodiment of the present invention.

FIG. 10 is a flowchart showing an operation performed when a user β purchases a usage right 500 and the user terminal 110 obtains the license data 1700 from the right management server 100 in the first embodiment of the present invention.

FIG. 11 is a flowchart showing an operation performed by the user terminal 110 when content is to be reproduced in the first embodiment of the present invention.

FIG. 12 is a flowchart showing an operation of reproduction propriety judgment processing in the first embodiment of the present invention.

FIG. 13 is a flowchart showing an operation performed by the user terminal 110 when the license data 1700 held in a license data DB 702 is to be upgraded in the first embodiment of the present invention.

FIG. 14 is a diagram showing a structure of data for license data upgrade 1400 in the first embodiment of the present invention.

FIG. 15 is a diagram showing an operation of upgrade propriety judgment processing in the first embodiment of the present invention.

FIG. 16 is a diagram showing an operation of the upgraded license data generation processing in the first embodiment of the present invention.

FIG. 17 is a diagram showing a structure of license data 600 in the first embodiment of the present invention.

FIG. 18 is a block diagram showing an overall structure of a digital content distribution system in a second embodiment of the present invention.

FIG. 19 is a diagram showing a structure of a right management server 1800 in the second embodiment of the present invention.

FIG. 20 is a diagram showing a structure of license data 2350 of the second embodiment.

FIG. 21 is a diagram showing a structure of a license data upgrade list 2000 in the second embodiment of the present invention.

FIG. 22 is a flowchart showing an operation performed when a license data upgrade list 2000 is generated in the second embodiment of the present invention.

FIG. 23 is a diagram showing a structure of a user terminal 1810 in the second embodiment of the present invention.

FIG. 24 is a diagram showing an example of a structure of a license data upgrade list request 2800.

FIG. 25 is a diagram showing an operation of upgrade propriety judgment processing in the second embodiment of the present invention.

FIG. 26 is a diagram showing a structure of license data 2300 in the second embodiment of the present invention.

FIG. 27 is a diagram showing an overall structure of a digital content distribution system in a third embodiment of the present invention.

FIG. 28 is a diagram showing a structure of a right management server 2500 in the third embodiment of the present invention.

FIG. 29 is a diagram showing a structure of a user usage right DB 2600 in the third embodiment of the present invention.

FIG. 30 is a flowchart showing an operation performed when a license data upgrade list 2000 is generated in the third embodiment of the present invention.

FIG. 31 is a diagram showing a structure of a license data upgrade list request 2900 in the third embodiment of the present invention.

FIG. 32 is a diagram showing a structure of a license data upgrade list 3000 generated by an upgrade list generating unit 1900.

### BEST MODE FOR CARRYING OUT THE INVENTION

### First Embodiment

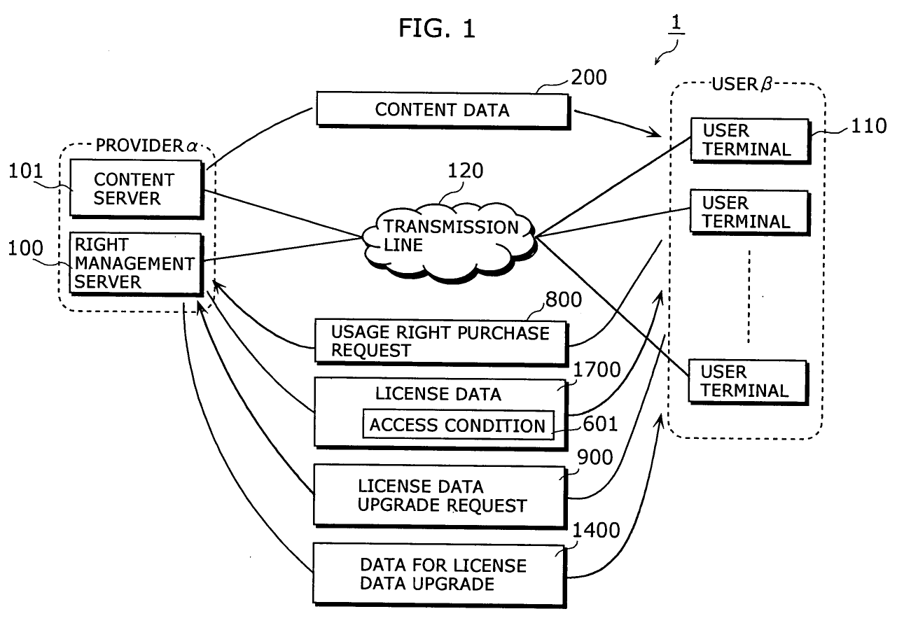

FIG. 1 is a block diagram showing an overall structure of a digital content distribution system in the first embodiment of the present invention.

As shown in FIG. 1, a digital content distribution system 1 is composed of: at least one right management server 100; at least one content server 101; at least one user terminal 110; and a transmission line 120.

The content server 101 is provided for the side of a provider α concerned with content distribution, and distributes content data 200 to the user terminal 110.

The right management server 100 is also provided for the provider α as with the content server 101, and manages a usage right for each set of content. In accordance with a usage right purchase request 800 from the user terminal 110, the right management server 100 distributes the usage right and an access condition 601 as license data 1700 to the user terminal 110. Also, in accordance with a license data upgrade request 900 from the user terminal 110, the right management server 100 distributes data for license data upgrade 1400 to the user terminal 110.

The user terminal 110 receives content distribution service, and is provided for the side of a user β. The user terminal 110 receives the content data 200 distributed by the content server 101. By transmitting the usage right purchase request 800, the user terminal 110 receives the license data 1700 from the right management server 100 to use the content. On the basis of the license data 1700, the user terminal 110 uses the content. Moreover, by transmitting the license data upgrade request 900 on the basis of the access condition 601 included in the license data 1700, the user terminal 110 receives the data for license data upgrade 1400 of the latest version from the right management server 100. Then, the user terminal 110 updates the original license data 1700 to the license data of the data for license data upgrade 1400.

The transmission line 120 is a cable transmission line or a wireless transmission line used for connecting the right management server 100 and the content server 101 with the user terminal 110 to enable data communication between them.

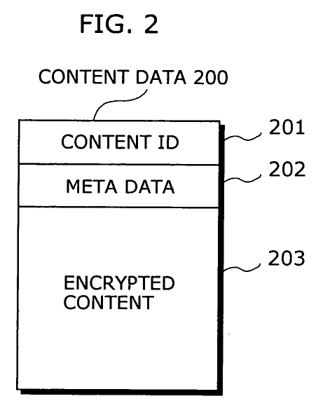

As shown in FIG. 2, the content data 200 is made up of a content ID 201, meta data 202, and encrypted content 203. The content ID 201 is an ID used for uniquely identifying the content in the digital content distribution system. The meta data 202 explains details of the content, so describes a title of the content, a name of an artist, or the like. The encrypted content 203 is made up of encrypted content, such as music data or image data.

It should be noted that the content is not limited to music data or image data, and may be an electronic newspaper, an electronic book, an electronic map, an electronic dictionary, a still picture, a game, a piece of computer software, or other digital content. Although the right management server 100 and the content server 101 are provided for the side of the provider α in the first embodiment, the right management server 100 and the content server 101 may be operated by different providers.

Next, a specific structure of the right management server 100 is explained.

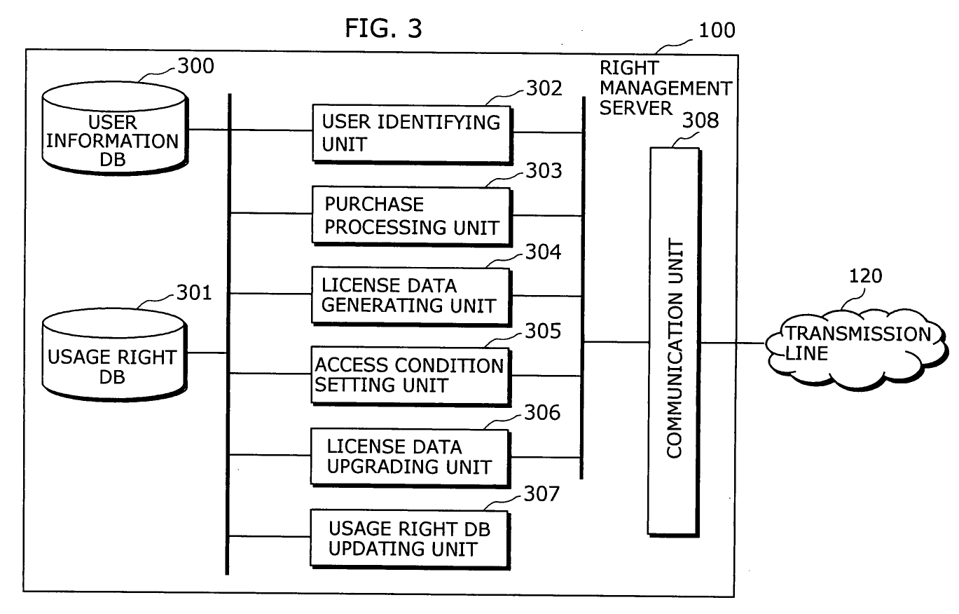

FIG. 3 is a block diagram showing a functional structure of the right management server 100.

As shown in FIG. 3, the right management server 100 is composed of a user information DB (Database) 300, a usage right DB 301, a user identifying unit 302, a purchase processing unit 303, a license data generating unit 304, an access condition setting unit 305, a license data upgrading unit 306, a usage right DB updating unit 307, and a communication unit 308.

The user information DB 300 is used for managing information regarding the user β.

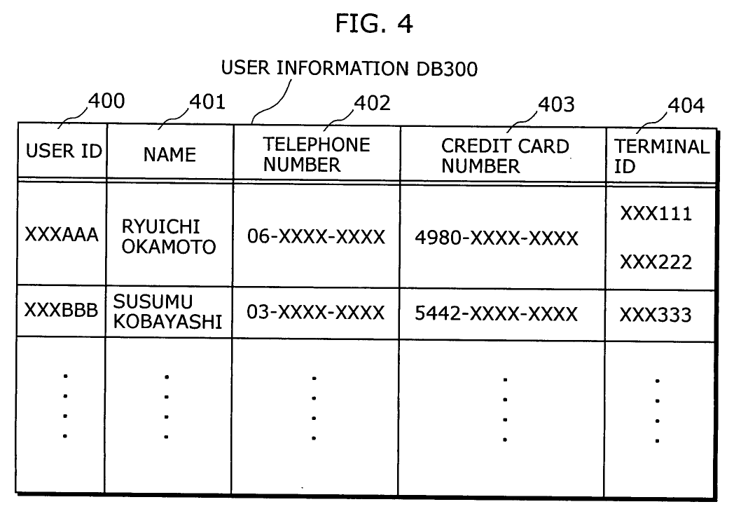

FIG. 4 shows an example of a structure of the user information DB 300.

As shown in FIG. 4, the user information DB 300 is made up of fields such as a user ID 400, a name 401, a telephone number 402, a credit card number 403, and a terminal ID 404.

The user ID 400 is used for uniquely identifying the user β in the digital content distribution system. The name 401 is a name of the user β. The telephone number 402 is a telephone number of the user β. The credit card number 403 is a number of a credit card which is used by the user β for payment of a purchased usage right of content. The terminal ID 404 is an ID of a terminal owned by the user β and used for uniquely identifying the user terminal 110 in the digital content distribution system.

FIG. 4 shows, for example, that: the user β is identified by the user ID “xxxAAA”; his name is “Ryuichi Okamoto”; his telephone number is “06-xxxx-xxxx”; the number of his credit card to be used for payment is “4980-xxxx-xxxx”; and he owns two terminals respectively having terminal IDs “xxx111” and “xxx222”.

Data is entered into the user information DB 300 when the user β performs user registration processing to receive a content distribution service operated by the provider α. This user registration processing may be performed through communication between the user β and the provider α via the transmission line 120. Alternatively, the user β may send a user registration document to the provider α. Or, the processing may be performed according to other methods. In the user registration processing, the provider α first assigns the user ID 400 to the user β. After this, by the communication or the received document, the provider α is informed of necessary information, such as the name 401, the telephone number 402, the credit card number 403, and the terminal ID 404 of the user terminal 110 owned by the user β. This informed information is entered into the user information DB 300 in association with the user ID 400 having been assigned to the user β earlier. As a result of such user registration processing, the user information DB 300 as shown in FIG. 4 is formed.

The usage right DB 301 is used for managing usage rights of content.

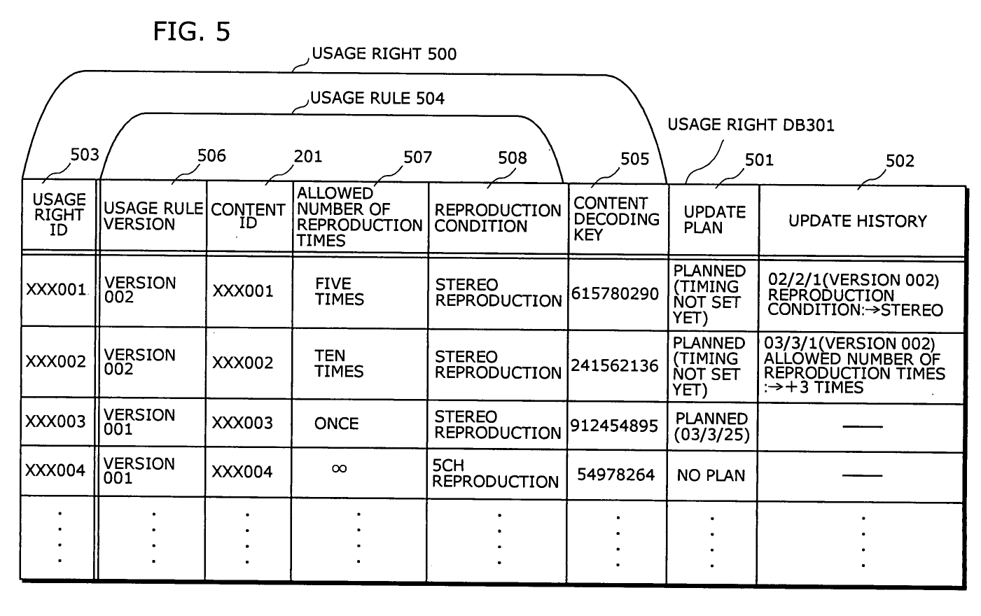

FIG. 5 shows an example of a structure of the usage right DB 301.

As shown in FIG. 5, the usage right DB 301 is made up of: a usage right 500 for each set of content; an update plan 501 showing an update plan of the usage right 500; and an update history 502 showing an update history of the usage right 500. The usage right 500 includes a usage right ID 503, a usage rule 504, and a content decoding key 505. The usage rule 504 includes a usage rule version 506, a content ID 201, an allowed number of reproduction times 507, and a reproduction condition 508.

The usage right ID 503 is used for uniquely identifying the usage right 500 in the digital content distribution system 1. The usage rule version 506 is information showing a version of the usage rule 504. The content ID 201 describes an ID of content which is an application object of the usage right 500. The allowed number of reproduction times 507 is the number of times the content can be reproduced. The reproduction condition 508 is information designating a condition for content reproduction. For example, if “monaural reproduction” is designated, the user terminal 110 has to reproduce the content in monaural sound. The content decoding key 505 is used for decoding the content identified by the content ID 201.

FIG. 5 shows, for example, that: the usage right 500 having “xxx001” as the usage right ID 503 is for content having “xxx001” as the content ID 201; the decoding key for decoding the content is “615780290”; the version of the usage rule 504 is “version 002”; the allowed number of reproduction times is “five times”; and the condition for reproduction is “stereo reproduction”. Moreover, FIG. 5 shows that although the usage right 500 having “xxx001” as the usage right ID 503 will be updated, the update timing and details have yet to be set. FIG. 5 also shows that the usage rule 504 was upgraded to version 002 on Feb. 1, 2002, and that the information regarding the upgrade is that the reproduction condition 508 was changed to “stereo reproduction”.

The user identifying unit 302 (see FIG. 3) identifies the user β by reference to the user information DB 300 on the basis of the terminal ID 404 transmitted from the user terminal 110.

The purchase processing unit 303 performs necessary billing processing and the like in response to a purchase request for a usage right from the user terminal 110.

The license data generating unit 304 generates the license data 1700 on the basis of the usage right 500 managed in the usage right DB 301.

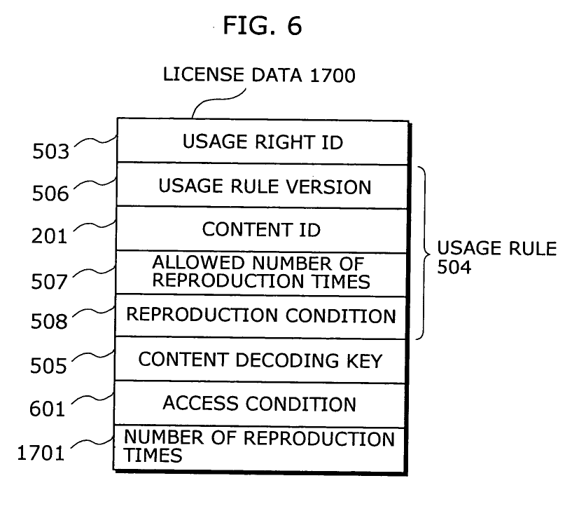

FIG. 6 shows a structure of the license data 1700 generated by the license data generating unit 304.

As shown in FIG. 6, the license data 1700 is made up of the usage right ID 503, the usage rule 504, the content decoding key 505, an access condition 601, and a number of reproduction times 1701.

Note that when generating the license data 1700, the license data generating unit 304 sets the usage right ID 503, the usage rule 504, and the content decoding key 505 as those of the usage right 500 based on which the license data 1700 is to be generated. The license data generating unit 304 sets the number of reproduction times 1701 at “0” as an initial value. To be more specific, this number of reproduction times 1701 is the number of times the content has been actually reproduced. The initial value is “0” and the number is increased by “1” every time the content is reproduced. The allowed number of reproduction times 507 of the license data 1700 represents the maximum number of times the content is allowed to be reproduced. This means that only if the number of reproduction times 1701 is less than the allowed number of reproduction times 507, the content reproduction is allowed. It should be noted that the access condition 601 is set by the access condition setting unit 305.

The access condition setting unit 305 sets an appropriate condition to the access condition 601 of the license data 1700. Here, the access condition 601 refers to information designating a condition for the user terminal 110 to access the right management server 100. The information includes a date and time of access, a frequency of access, and flag information as to whether or not access is necessary. In the first embodiment, the access condition 601 is used in order to inform the user terminal 110 of the timing to issue a request for an upgrade of the license data 1700. By reference to the update plan 501 of the usage right DB 301, the access condition setting unit 305 sets a condition so as to allow the user terminal 110 to issue the request for an upgrade of the license data 1700 at the appropriate timing.

A more specific explanation is given as to a case where the license data 1700 is issued on the basis of the usage right 500 in which the usage right ID 503 is “xxx003” as shown in FIG. 5, for example. In this case, the usage right 500 is to be updated on Mar. 25, 2003. As such, the access condition setting unit 305 sets a condition as “access on 2003/3/25” to the access condition 601.

Also, see a case where the license data 1700 is issued on the basis of the usage right 500 in which the usage right ID 503 is “xxx001”. In this case, the usage right 500 is to be updated but its timing has yet to be set. Thus, the access condition setting unit 305 sets a condition that is considered to be appropriate, such as “access once a week”, to the access condition 601 according to a rule predetermined by the provider α. In a case where the license data 1700 is issued on the basis of the usage right 500 in which the usage right ID 503 is “xxx004”, the usage right 500 is not to be updated. As such, the access condition setting unit 305 sets a condition as “unnecessary to access” to the access condition 601.

In the first embodiment, the access condition 601 is used for informing the user terminal 110 of the timing to issue the request for an upgrade of the license data 1700. However, the use of the access condition 601 is not limited to this and may be used when it is necessary to direct the user terminal 110 to access the right management server 100 for some reason.

Back to FIG. 3, in response to the request issued by the user terminal to upgrade the license data 1700, the license data upgrading unit 306 performs processing and transmits data used for upgrading the license data 1700 to the user terminal 110. The specific processing performed when the license data 1700 is upgraded will be described in detail later with reference to the flowchart.

The usage right DB updating unit 307 updates the usage right DB 301. To be more specific, the usage right DB updating unit 307 updates the usage right 500 stored in the usage right DB 301 according to an instruction from the provider α and records the details of the update into the update history 502. It should be noted that the provider α updates the details of the usage right 500 as necessary like for the purpose of sales promotion, for example.

The communication unit 308 communicates with the user terminal 110 via the transmission like 120.

Next, an explanation is given as to a specific structure of the user terminal 110.

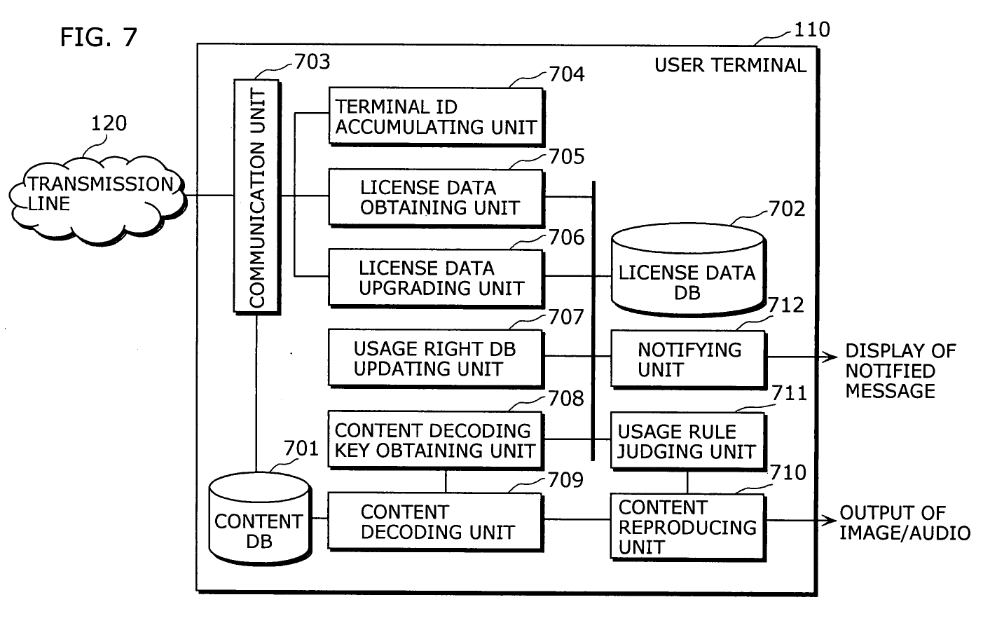

FIG. 7 is a block diagram showing a functional structure of the user terminal 110.

As shown in FIG. 7, the user terminal 110 is composed of a content DB 701, a license data DB 702, a communication unit 703, a terminal ID accumulating unit 704, a license data obtaining unit 705, a license data upgrading unit 706, a license data DB updating unit 707, a content decoding key obtaining unit 708, a content decoding unit 709, a content reproducing unit 710, a usage rule judging unit 711, and a notifying unit 712.

The content DB 701 is used for managing the content data 200 distributed by the content server 101.

The license data DB 702 is used for managing the license data 1700 distributed by the right management server 100.

The communication unit 703 communicates with the right management server 100 and the content server 101 via the transmission line 120.

The terminal ID accumulating unit 704 accumulates the terminal ID 404 that uniquely identifies the user terminal 110 in the digital content distribution system.

The license data obtaining unit 705 generates the usage right purchase request 800 and transmits it to the right management server 100. By doing so, the license data obtaining unit 705 purchases the usage right of the content and obtains the license data 1700.

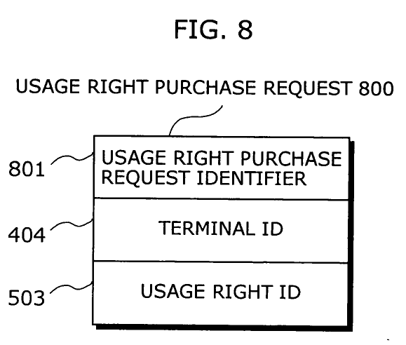

As shown in FIG. 8, the usage right purchase request 800 is made up of a usage right purchase request identifier 801, the terminal ID 404, and the usage right ID 503.

The usage right purchase request identifier 801 describes information showing that the present data is the usage right purchase request 800. The terminal ID 404 describes the ID of the user terminal 110 which issues the usage right purchase request 800. The usage right ID 503 describes the ID of the usage right 500 which is requested for.

The license data upgrading unit 706 upgrades the license data 1700 stored in the license data DB 702. To be more specific, the license data upgrading unit 706 first references to the access condition 601 for each set of license data 1700 stored in the license data DB 702 and judges whether there is a set of license data 1700 whose update timing is coming. If judging there is, the license data upgrading unit 706 generates the license data upgrade request 900 and transmits it to the right management server 100 in order to request for an update of the license data 1700.

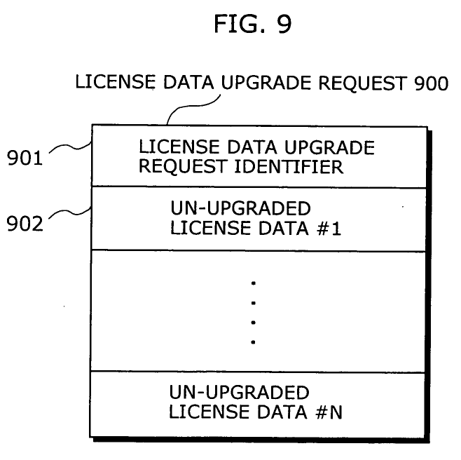

FIG. 9 is a diagram showing a structure of the license data upgrade request 900.

As shown in FIG. 9, the license data upgrade request 900 is made up of a license data upgrade request identifier 901 and N sets of un-upgraded license data 902. Here, N is an integer equal to or more than one.

The license data upgrade request identifier 901 describes information showing that the present data is the license data upgrade request 900. The un-upgraded license data 902 describes the license data 1700 whose upgrade timing is judged to be coming.

The license data DB updating unit 707 updates the license data DB 702. To be more specific, in the first embodiment of the present invention, every time the content is reproduced, the value as the number of reproduction times 1701 in the license data 1700 stored in the license data DB 702 is increased by one.

The content decoding key obtaining unit 708 fetches the content decoding key 505 used for decoding the content from the license data 1700 stored in the license data DB 702.

The content decoding unit 709 fetches the content data 200 from the content DB 701 and decodes the encrypted content 203 in the fetched content data 200 using the content decoding key 505 obtained by the content decoding key obtaining unit 708.

The content reproducing unit 710 reproduces the content decoded by the content decoding unit 709 in accordance with the condition designated by the reproduction condition 508 in the license data 1700. Music and images are outputted respectively from a speaker and a display which are not illustrated in the diagram.

The usage rule judging unit 711 judges whether the content can be reproduced, by reference to the allowed number of reproduction times 507 and the number of reproduction times 1701 in the license data 1700.

The notifying unit 712 notifies the user β of various messages.

Next, an operation performed by the digital content distribution system 1 of the first embodiment is explained using the flowcharts.

First, an explanation is given as to an operation performed when the user β purchases the usage right 500 of the content and the user terminal 110 obtains the license data 1700 from the right management server 100.

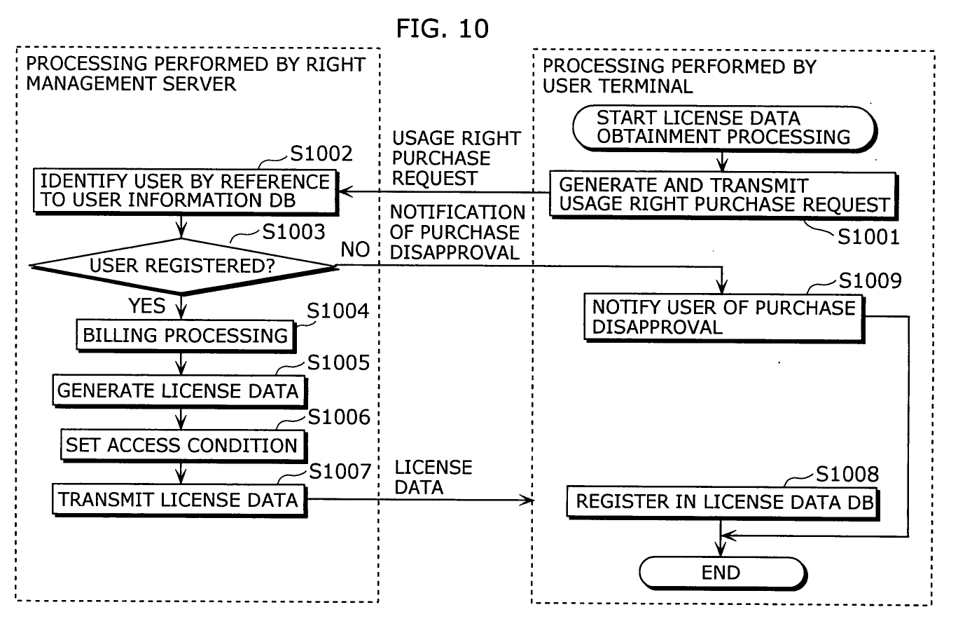

FIG. 10 is a flowchart showing an operation of license data obtainment processing performed between the user terminal 110 and the right management server 100.

S1001: The license data obtaining unit 705 of the user terminal 110 receives a usage right purchase instruction from the user β via a user operation inputting unit, such as a keyboard, that is not illustrated. Note that this usage right purchase instruction includes the usage right ID 503 of the usage right 500 which the user β wishes to purchase. In response to the usage right purchase instruction from the user β, the license data obtaining unit 705 generates the usage right purchase request 800 and transmits it to the right management server 100 via the communication unit 703. Here, note that the terminal ID 404 held by the terminal ID accumulating unit 704 is set as the terminal ID 404 of the usage right purchase request 800 while the usage right ID 503 included in the usage right purchase instruction from the user β is set as the usage right ID 503.

S1002: Receiving the usage right purchase request 800 via the communication unit 308, the user identifying unit 302 of the right management server 100 identifies the user β who wishes to purchase the usage right 500, by reference to the user information DB 300 on the basis of the terminal ID 404 included in the usage right purchase request 800.

S1003: If the user β cannot be identified in step S1002, that is, if the user β has not been registered, the user identifying unit 302 informs the user terminal 110 of the purchase disapproval via the communication unit 308.

If the user β can be identified in step S1002, the processing proceeds to step S1004.

S1004: The purchase processing unit 303 performs the billing processing using the information regarding the user β identified by the user identifying unit 302.

S1005: The license data generating unit 304 generates the license data 1700 which is to be transmitted to the user terminal 110. Here, note that the usage right ID 503 included in the usage right purchase request 800 is set as the usage right ID 503 of the license data 1700 while the usage rule 504 and the content decoding key 505 of the usage right 500 identified by the usage right ID 503 included in the right purchase request 800 are respectively set as the usage rule 504 and the content decoding key 505 of the license data 1700. An initial value “0” is set to the number of reproduction times 1701. The access condition setting unit 305 sets the access condition 601 in step S1006 described next.

S1006: By reference to the update plan 501 of the usage right 500 which is identified by the usage right ID 503 included in the right purchase request 800, the access condition setting unit 305 sets a condition as the access condition 601 of the license data 1700 generated in step S1005 so that the user terminal 110 can issue a request for an upgrade of the license data 1700 at the appropriate timing.

S1007: The communication unit 308 transmits the license data 1700 completed in the processing performed in step S1006 to the user terminal 110.

S1008: The license data obtaining unit 705 of the user terminal 110 receives the license data 1700 transmitted in step S1007 via the communication unit 703 and enters the received license data 1700 into the license data DB 702. After this, the license data obtaining unit 705 notifies the user β via the notifying unit 712 that the purchase of the usage right 500 and the obtainment of the license data 1700 are completed, and then ends the processing.

S1009: If the user β is judged in step S1003 not to be registered, the license data obtaining unit 705 receives the notification of the purchase disapproval from the right management server 100 via the communication unit 703. In this case, the license data obtaining unit 705 notifies the user β via the notifying unit 712 that the usage right 500 could not be purchased, and then ends the processing.

Accordingly, through the processing described so far, the user β can purchase the usage right 500 of the content and the user terminal 110 can obtain the license data 1700.

In the first embodiment, if the user β is judged in step S1003 not to be registered, the user β is notified of the purchase disapproval and the processing is ended in S1009. However, the user registration processing may be performed immediately following step S1003 so that the processing from step S1004 onwards is executed.

Next, an explanation is given as to an operation performed by the user terminal 110 in the digital content distribution system 1 of the first embodiment when the content is to be reproduced.

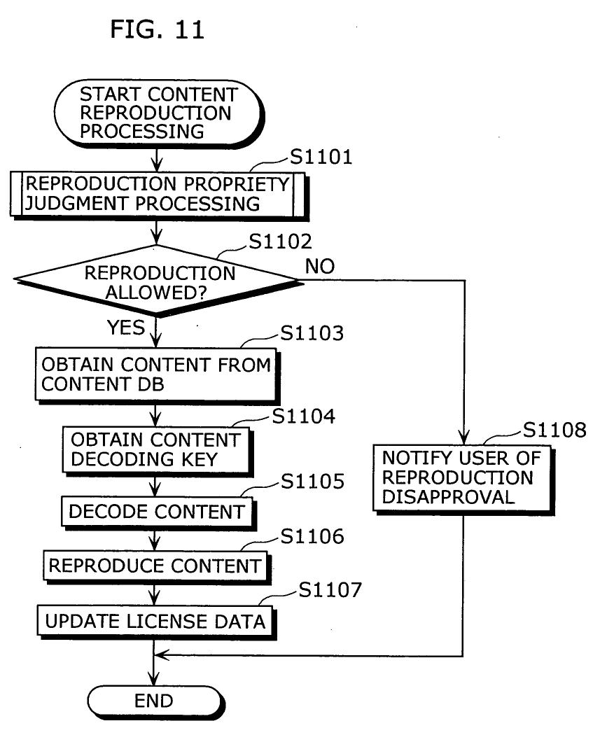

FIG. 11 is a flowchart showing an operation of content reproduction processing.

S1101: The usage rule judging unit 711 of the user terminal 110 receives a content reproduction instruction from the user β via the user operation inputting unit, such as a keyboard, that is not illustrated. Note that this content reproduction instruction from the user β includes information which identifies the content that the user β wishes to reproduce. The usage rule judging unit 711 performs reproduction propriety judgment processing and judges whether or not reproduction of the content is allowed.

S1102: If the reproduction of the content is judged to be allowed in step S1101, the processing proceeds to step S1103. If it is judged not to be allowed, the processing proceeds to step S1108.

S1103: The content decoding unit 709 fetches the content data 200 which the user β wishes to reproduce from the content DB 701.

S1104: The content decoding key obtaining unit 708 fetches the content decoding key 505 from the license data 1700 corresponding to the content that the user β wishes to reproduce.

S1105: The content decoding unit 709 decodes the encrypted content 203 included in the content data 200 which was fetched in step S1103, using the content decoding key 505 obtained by the content decoding key obtaining unit 708 in step S1104.

S1106: The content reproducing unit 710 reproduces the encrypted content 203 which was decoded by the content decoding unit 709 in step S1105, under the condition designated by the reproduction condition 508 in the license data 1700.

S1107: The license data DB updating unit 707 adds “1” to the value of the number of reproduction times 1701 in the license data 1700 that was used for the reproduction.

S1108: The usage rule judging unit 711 notifies the user β via the notifying unit 712 that the content is not allowed to be reproduced.

Through the processing described so far, the user terminal 110 reproduces the content.

Next, a detailed explanation is given as to the reproduction propriety judgment processing performed in step S1101 of FIG. 11.

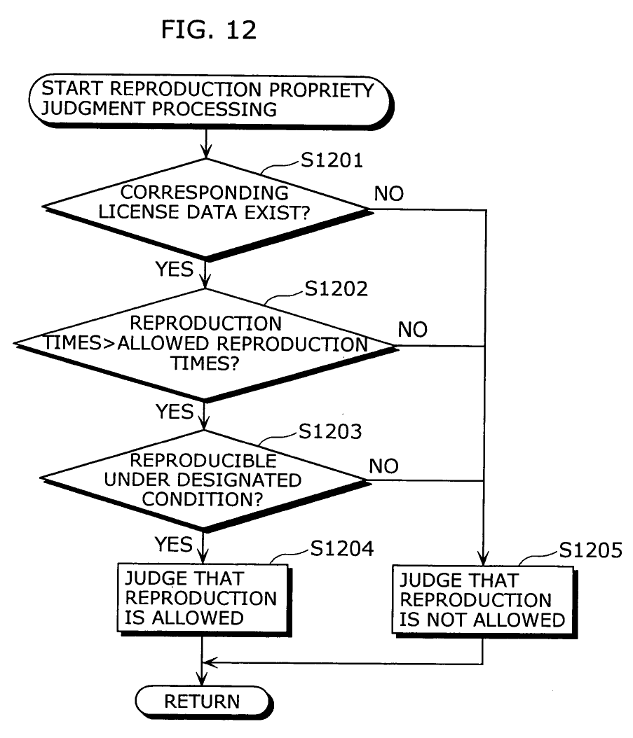

FIG. 12 is a flowchart showing a subroutine of the reproduction propriety judgment processing (S1101) shown in FIG. 11.

The reproduction propriety judgment processing is performed for a judgment as to whether or not the reproduction of the content requested by the user β is allowed.

S1201: The usage rule judging unit 711 of the user terminal 110 judges whether the license data 1700 corresponding to the content which the user β wishes to reproduce exists in the license data DB 702. If the corresponding license data 1700 exists, the processing proceeds to step S1202. If the corresponding license data 1700 does not exist, the processing proceeds to step S1205.

S1202: The usage rule judging unit 711 judges whether the number of reproduction times 1701 of the license data 1700 corresponding to the content which the user β wishes to reproduce is less than the allowed number of reproduction times 507. If the number of reproduction times 1701 is less than the allowed number of reproduction times 507, the processing proceeds to step S1203. If the number of reproduction times 1701 is equal to or more than the allowed number of reproduction times 507, the processing proceeds to step S1205.

S1203: By reference to the reproduction condition 508 of the license data 1700 corresponding to the content which the user β wishes to reproduce, the usage rule judging unit 711 judges whether the content reproducing unit 710 can reproduce the content under the condition designated by the reproduction condition 508. If the reproduction is judged to be allowed under the designated condition, the processing proceeds to step S1204. If the reproduction is judged not to be allowed under the designated condition, the processing proceeds to step S1205.

S1204: The usage rule judging unit 711 judges that the content can be reproduced.

S1205: The usage rule judging unit 711 judges that the content cannot be reproduced.

In this way, the reproduction propriety judgment processing is performed.

Next, an explanation is given as to an operation performed by the user terminal 110 in the digital content distribution system 1 of the first embodiment when the license data 1700 held in the license data DB 702 is upgraded.

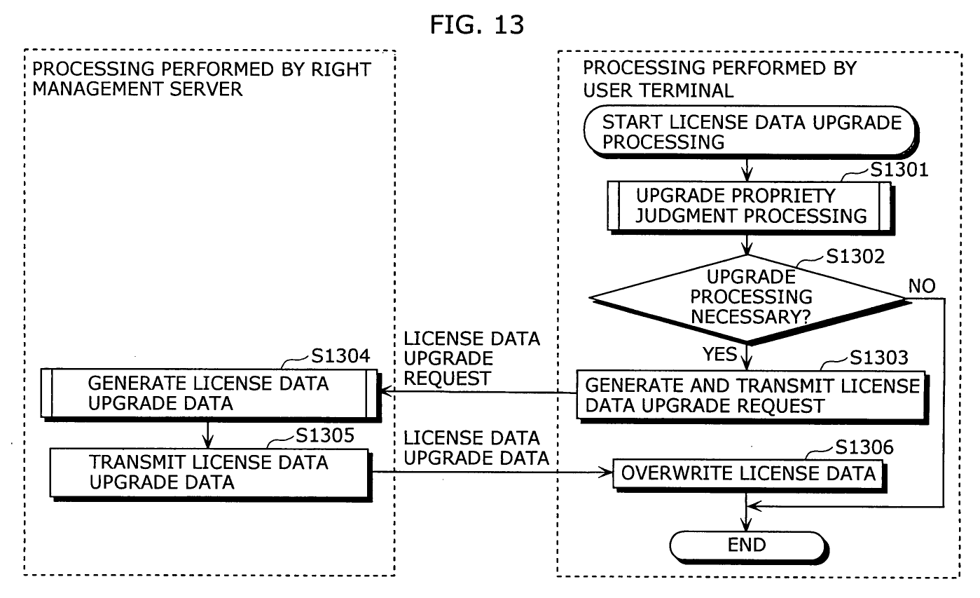

FIG. 13 is a flowchart showing an operation of license data upgrade processing performed between the user terminal 110 and the right management server 100.

S1301: The license data upgrading unit 706 of the user terminal 110 receives an instruction to start the license data upgrade processing from the user β via the user operation inputting unit, such as a keyboard, that is not illustrated. The license data upgrading unit 706 executes upgrade propriety judgment processing and judges whether the upgrade processing is necessary.

Next, an explanation is given as to the upgrade propriety judgment processing (S1301) in FIG. 13.

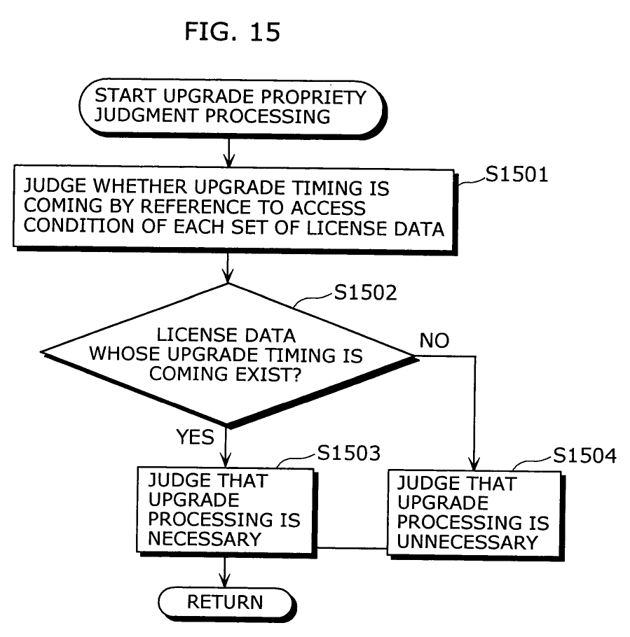

FIG. 15 is a flowchart showing a subroutine of the upgrade propriety judgment processing (S1301) in FIG. 13.

The upgrade propriety judgment processing is performed for a judgment as to whether the upgrade processing needs to be performed on the license data 1700.

S1501: By reference to the access condition 601 for each set of the license data 1700 stored in the license data DB 702, the license data upgrading unit 706 judges whether the timing to upgrade the data is coming.

S1502: If judging there is the license data 1700 whose upgrade timing is coming in step S1501, the processing proceeds to step S1503. If judging there is no license data 1700 whose upgrade timing is coming, the processing proceeds to step S1504.

S1503: The license data upgrading unit 706 judges that the upgrade processing needs to be performed.

S1504: The license data upgrading unit 706 judges that the upgrade processing does not need to be performed.

In this way, the upgrade propriety judgment processing is performed.

S1302: If the upgrade processing is judged to be necessary in step S1301, the processing proceeds to step S1303. If the upgrade processing is judged not to be necessary, the processing is ended here.

S1303: The license data upgrading unit 706 generates the license data upgrade request 900 shown in FIG. 9 and transmits it to the right management server 100 via the communication unit 703. Here, note that that the license data upgrading unit 706 describes the license data 1700 whose upgrade timing is judged to be coming in step S1302 into the un-upgraded license data 902 in the license data upgrade request 900.

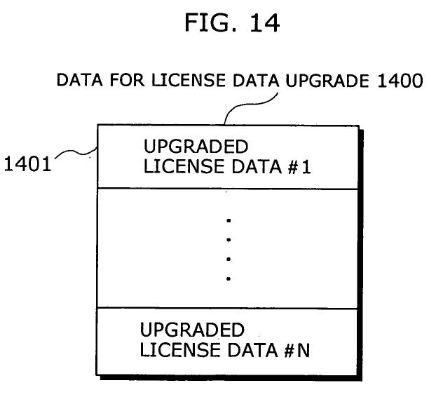

S1304: Receiving the license data upgrade request 900 via the communication unit 308, the license data upgrading unit 306 of the right management server 100 performs upgraded license data generation processing for each of the N sets of the un-upgraded license data 902 included in the request 900. By doing so, the license data upgrading unit 306 generates N sets of upgraded license data 1401. After this, the license data upgrading unit 306 arranges the generated N sets of the upgraded license data 1401 in the same order as the un-upgraded license data 902 arranged in the license data upgrade request 900 so as to generate the data for license data upgrade 1400 shown in FIG. 14.

Next, a detailed explanation is given as to the upgraded license data generation processing (S1304) in FIG. 13.

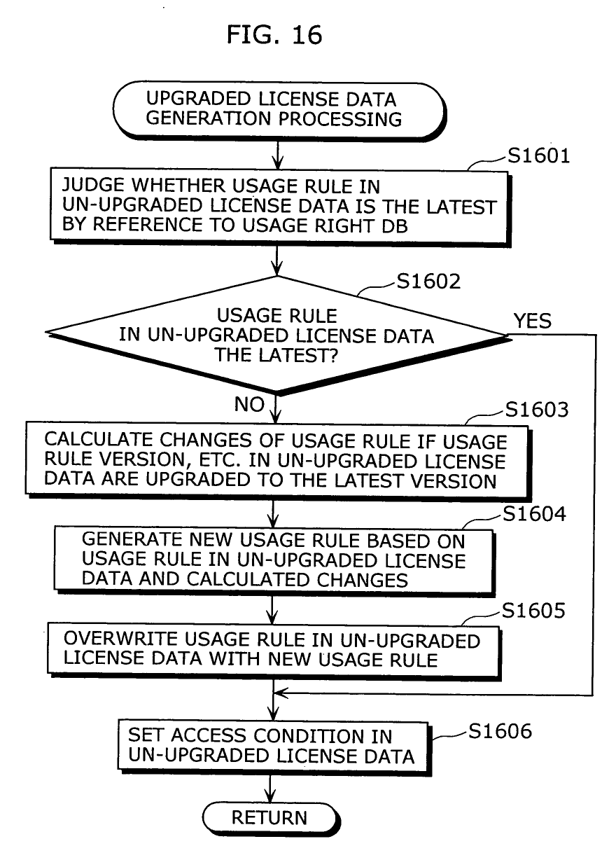

FIG. 16 is a flowchart showing a subroutine of the upgraded license data generation processing (S1304) in FIG. 13.

S1601: The license data upgrading unit 306 compares the usage rule version 506 in the un-upgraded license data 902 with the usage rule version 506 in the usage right DB 301 and judges whether the usage rule 504 in the un-upgraded license data 902 is the latest.

S1602: If the usage rule 504 is judged not to be the latest in step S1601, the processing proceeds to step S1603. If the usage rule 504 is judged to be the latest, the processing proceeds to step S1606.

S1603: The license data upgrading unit 306 calculates changes to be caused to the usage rule 504 if the usage rule version 506, etc. in the un-upgraded license data 902 are upgraded to the latest version.

S1604: The license data upgrading unit 306 generates a new usage rule 504 on the basis of the usage rule 504 in the un-upgraded license data 902 and the changes calculated in step S1603.

S1605: The license data upgrading unit 306 overwrites the usage rule 504 in the un-upgraded license data 902 with the new usage rule 504 generated in step S1604.

S1606: By reference to the update plan 501 of the usage right DB 301, the license data upgrading unit 306 resets the access condition 601 in the un-upgraded license data 902 to an appropriate condition.

By performing the processing described so far on the un-upgraded license data 902, the license data upgrading unit 306 generates the upgraded license data 1401.

In this way, the upgraded license data generation processing is performed.

S1305: The license data upgrading unit 306 transmits the data for license data upgrade 1400 generated in step S1304 to the user terminal 110 via the communication unit 308.

S1306: The license data upgrading unit 706 of the user terminal 110 receives the data for license data upgrade 1400 via the communication unit 703. The license data upgrading unit 706 overwrites the corresponding license data 1700 in the license data DB 702 using the upgraded license data 1401 included in the received data for license data upgrade 1400.

Through the processing described so far, the user terminal 110 can upgrade the license data 1700 held in the license data DB 702.

Accordingly, using the digital content distribution system 1 of the present invention, the first effect can be achieved by the user terminal that can access the right management server at the appropriate timing in order to update the received license data. In addition, the second effect can be achieved by the right management server that can upgrade the license data transmitted to the user terminal at the appropriate timing.

In the first embodiment, this license data upgrade processing is started in accordance with an instruction from the user β. However, the processing may be performed in accordance with a predetermined date and time or frequency, such as “at 12 o'clock every day” or “once a day”. Alternatively, the processing may be started when the user terminal 110 performs a predetermined operation, such as “at power-up”.

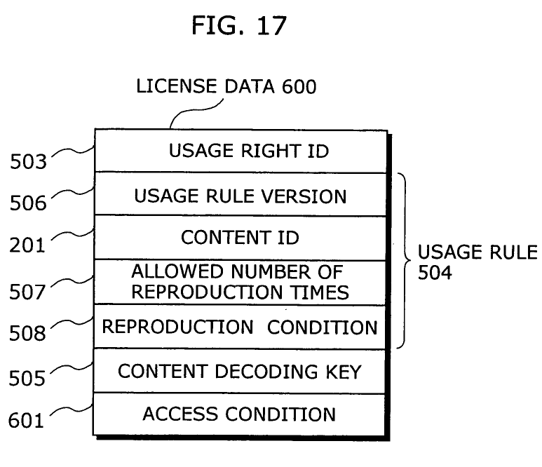

It should be noted that the license data distributed from the right management server 100 to the user terminal 110 may have a format like the license data 600 shown in FIG. 17 where the number of reproduction times 1701 is deleted from the license data 1700 shown in FIG. 6.

The allowed number of reproduction times 507 of this license data 600 indicates the number of times the content is allowed to be reproduced in the future. Starting at the initial value, the number is reduced by “one” every time the content is reproduced.

In this case, when the content is reproduced, the license data DB updating unit 707 performs processing to subtract one from the value of the allowed number of reproduction times 507 instead of processing to add one to the number of reproduction times 1701 (processing performed in step S1107 of the flowchart shown in FIG. 11). Moreover, the usage rule judging unit 711 judges in the reproduction propriety judgment processing whether the allowed number of reproduction times 507 is one or more instead of judging whether the number of reproduction times 1701 is less than the allowed number of reproduction times 507 (processing performed in step S1202 of the flowchart shown in FIG. 12).

It should be noted that an addition operation may not be performed on the number of reproduction times 1701 of the license data 1700 and 600 when the data is distributed from the right management server 100 to the user terminal 110, and the addition operation may be performed by the user terminal 110.

In the first embodiment, the N sets of the license data 1700 to be upgraded are described in the license data upgrade request 900. However, the whole license data 1700 does not necessarily have to be described. For example, N pairs of the usage right ID 503 and the usage rule 504 may be described.

In this case, the license data upgrading unit 306 transmits data including N combinations of the usage right ID 503, the newly generated usage rule 504 (which is generated through the same processing as performed in steps S1603 and S1604 of the flowchart shown in FIG. 16), and the access condition 601 as the data for license data upgrade 1400 to the user terminal 110. Using the received new usage rule 504 and access condition 601, the user terminal 110 overwrites the usage rule 504 and the access condition 601 of the corresponding license data 1700 stored in the license data DB 702.

Moreover, instead of the N sets of the license data 1700, N usage right IDs 503 may be described in the license data upgrade request 900. In this case, the license data upgrading unit 306 transmits data including N combinations of the usage right ID 503, the corresponding latest usage rule 504, and the corresponding latest access condition 601 as the data for license data upgrade 1400 to the user terminal 110. Using the received latest usage rule 504 and access condition 601, the user terminal 110 overwrites the usage rule 504 and the access condition 601 of the corresponding license data 1700 stored in the license data DB 702.

### Second Embodiment

The following is an explanation as to a digital content distribution system of the second embodiment of the present invention.

A digital content distribution system 2 of the second embodiment has almost the same structure as the digital content distribution system 1 of the first embodiment, and its operation is different only in part. On account of this, only the difference with the first embodiment will be described in the present embodiment. Note that the common components are assigned the same numerals in the drawings of the embodiments.

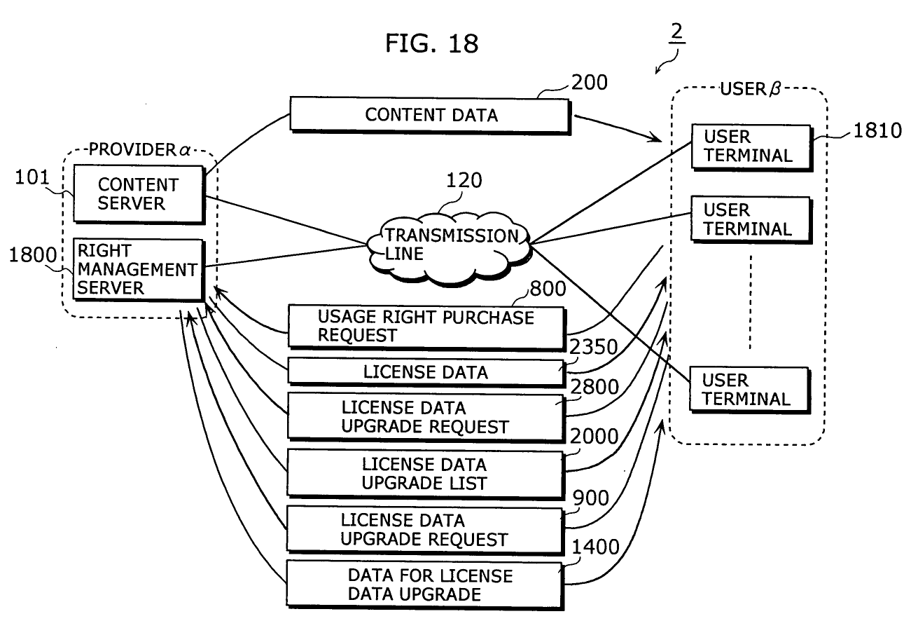

FIG. 18 is a block diagram showing an overall structure of the digital content distribution system 2 of the second embodiment.

The overall structure of the digital content distribution system 2 of the second embodiment is the same as that of the digital content distribution system 1 of the first embodiment that was explained with reference to FIG. 1. Therefore, the explanation is omitted here.

It should be noted that different numerals are given to a right management server 1800 and a user terminal 1810 in FIG. 18 than the numerals given to the right management server 100 and the user terminal 110 in FIG. 1 of the first embodiment since their internal structures are slightly different.

Incidentally, according to the digital content distribution system 1, the right management server 100 transmits the license data 1700 including the access condition 601 to the user terminal 110, which then transmits the license data upgrade request 900 on the basis of the access condition 601 to the right management server 100.

According to the digital content distribution system 2, on the other hand, the right management server 1800 transmits license data 2350 which does not include the access condition 601 to the user terminal 1810. On account of this, having no way to know a upgrade plan of the obtained license data 2350, the user terminal 1810 transmits a license data upgrade list request 2800 to the right management server 1800 as necessary. Receiving the license data upgrade list request 2800, the right management server 1800 generates information specifying upgraded licenses as license data upgrade list 2000 for common use by all user terminals and transmits the generated license data upgrade list 2000 to the user terminal 1810. Then, on the basis of the received license data upgrade list 2000, the user terminal 1810 issues the license data upgrade request 900 for a license that needs an upgrade. This point is substantially different from the case of the digital content distribution system 1.

Next, an explanation is given as to a structure of the right management server 1800.

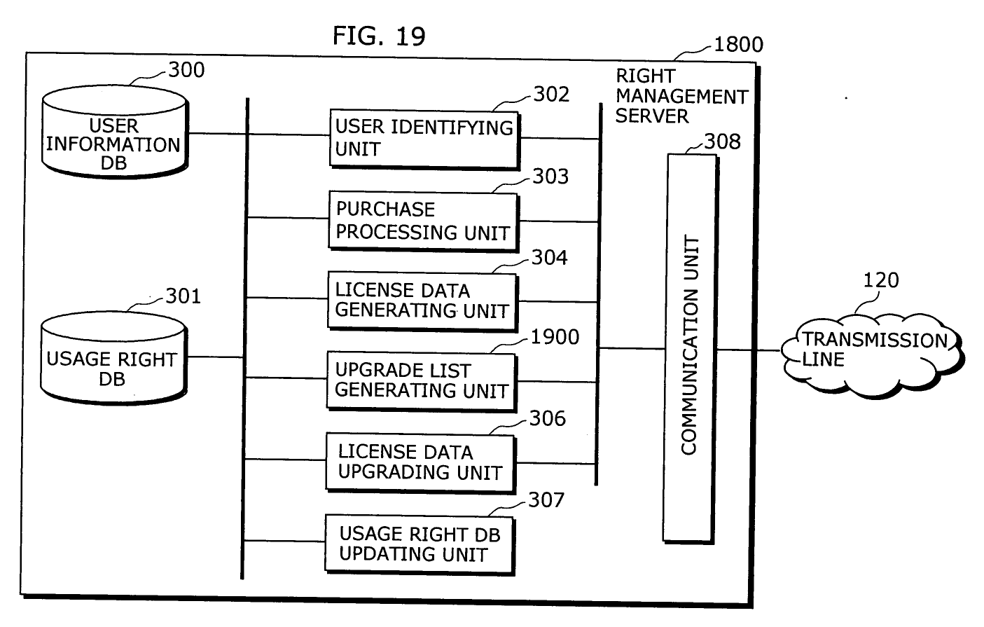

FIG. 19 is a diagram showing the structure of the right management server 1800 in the second embodiment. Note that components equivalent to those of the right management server 100 are given the same numerals and an explanation as to them is omitted.

The right management server 1800 of the second embodiment is different from the right management server 100 of the first embodiment in that the server 1800 is provided with an upgrade list generating unit 1900 instead of the access condition setting unit 305. Since the right management server 1800 is not provided with the access condition setting unit 305, the license data is generated only by the license data generating unit 304.

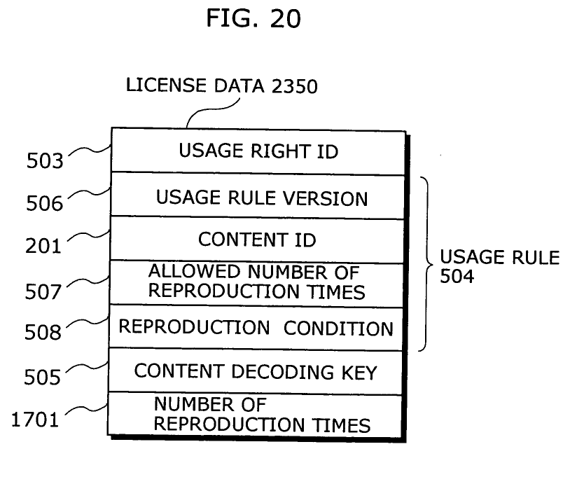

Here, the license data 2350 generated by the license data generating unit 304 in the second embodiment is shown in FIG. 20.

As shown in FIG. 20, the license data 2350 is made up of a usage right ID 503, a usage rule version 506, a content ID 201, an allowed number of reproduction times 507, a reproduction condition 508, a content decoding key 505, and a number of reproduction times 1701. Note that the license data 2350 is different from the license data 1700 of the first embodiment only in that the access condition 601 is not included. On this account, an explanation as to the components of the license data 2350 is omitted.

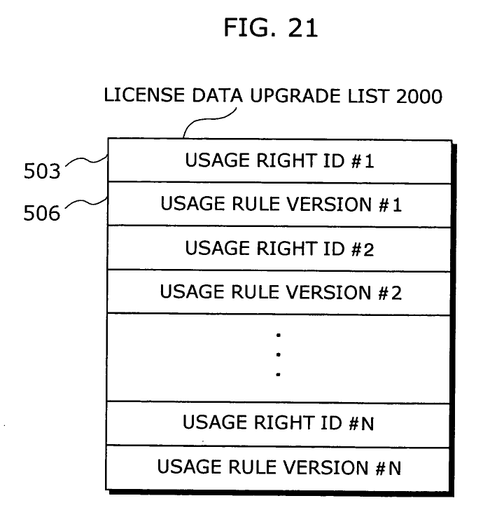

In response to the license data upgrade list request 2800 from the user terminal 1810, the upgrade list generating unit 1900 generates the license data upgrade list 2000 shown in FIG. 21 and transmits it to the user terminal 1810 via the communication unit 308.

Here, as shown in FIG. 21, the license data upgrade list 2000 is made up of N pairs of the usage right ID 503 and the usage rule version 506. The license data upgrade list 2000 is used for notifying the user terminal 1810 that the usage right 500 identified by the usage right ID 503 has been upgraded to the version indicated by the usage rule version 506. Here, N is an integer equal to or more than one.

Next, an explanation is given as to an operation performed by the upgrade list generating unit 1900 to generate the license data upgrade list 2000.

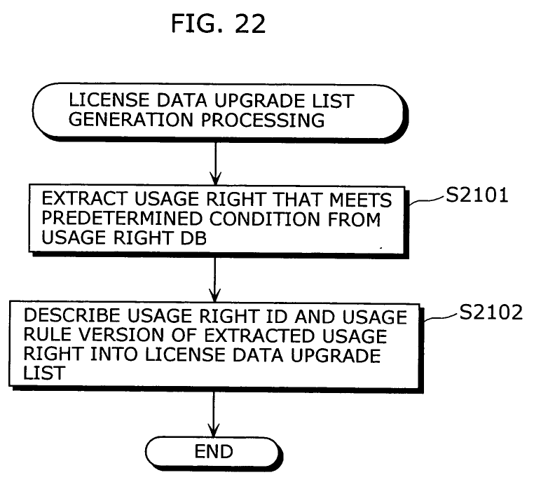

FIG. 22 is a flowchart showing an operation of license data upgrade list generation processing performed by the upgrade list generating unit 1900.

S2101: Receiving the license data upgrade list request 2800 via the communication unit 308, the upgrade list generating unit 1900 of the right management server 1800 references to the usage right DB 301 and extracts every usage right 500 that meets a condition predetermined by the provider α. As the condition predetermined by the provider α, a condition such as “the rights updated in the past week” can be considered, for example.

S2102: The upgrade list generating unit 1900 describes the usage right ID 503 and the usage rule version 506 of each usage right 500 extracted in step S2101 as a pair into the license data upgrade list 2000.

Through the processing described so far, the upgrade list generating unit 1900 generates the license data upgrade list 2000.

Next, the structure of the user terminal 1810 is explained.

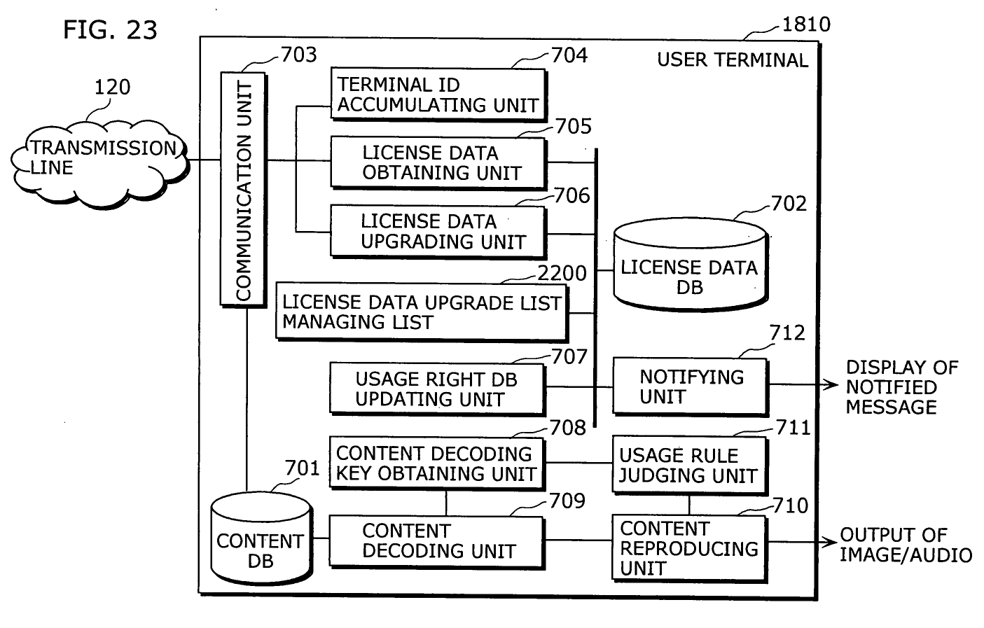

FIG. 23 is a diagram showing the structure of the user terminal 1810 in the second embodiment. The user terminal 1810 of the second embodiment is different from the user terminal 110 of the first embodiment in that a license data upgrade list managing unit 2200 is provided in addition to the components of the user terminal 110.

The license data upgrade list managing unit 2200 obtains the license data upgrade list 2000 from the right management server 1800 and manages the list 2000. In accordance with an instruction from the user or a predetermined rule given by the provider α as a predetermined timing (like “at power-up” or “every Saturday”), for example, the license data upgrade list managing unit 2200 transmits the license data upgrade list request 2800 to the right management server 1800 to obtain the license data upgrade list 2000.

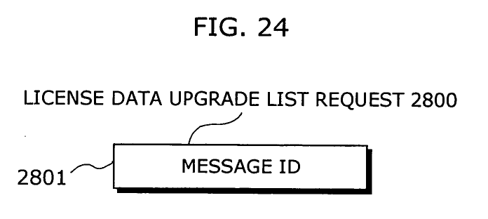

FIG. 24 is a diagram showing an example of a structure of the above-mentioned license data upgrade list request 2800.

As shown in FIG. 24, the license data upgrade list request 2800 is made up of only a message ID 2801 indicating that it is a request for a license data upgrade list.

On the basis of this license data upgrade list 2000, the license data upgrading unit 706 of the second embodiment extracts the license data 2350 whose upgrade timing is coming.

Next, an explanation is given as to an operation of upgrade propriety judgment processing of the second embodiment.

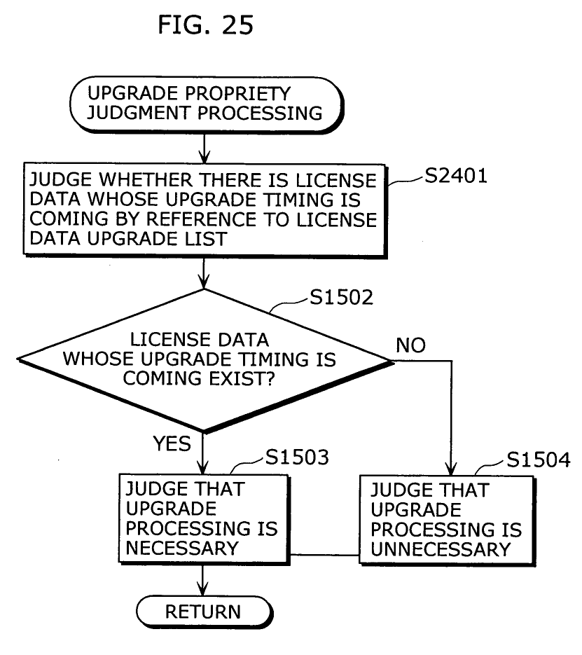

FIG. 25 is a flowchart showing a subroutine of the upgrade propriety judgment processing (S1301 in FIG. 13).

S2401: The license data upgrading unit 706 judges whether the license data DB 702 includes a set of license data 2350 whose update timing is coming, by reference to the license data DB 702 and the license data upgrade list 2000 managed by the license data upgrade list managing unit 2200. Here, the license data whose upgrade timing is coming refers to the license data 2350 that satisfies the following two conditions.

(Condition 1) The usage right ID 503 is described in the license data upgrade list 2000.

(Condition 2) The usage rule version 506 is older than the usage rule version 506 described in the license data upgrade list 2000.

The processing performed in steps S1502 to S1504 is the same as the upgrade propriety judgment processing explained with reference to FIG. 15 in the first embodiment. Thus, the explanation is omitted here.

Accordingly, the explanation as to the operation of the upgrade propriety judgment processing of the second embodiment is ended.

The other components or operations which are not explained in the present embodiment are the same as those in the first embodiment, except that the processing of setting the access condition 601 (performed in step S1006 in FIG. 10 as well as S1606 in FIG. 16) is not performed in the present embodiment. As such, the explanations of these components and operations are omitted here.

In the second embodiment, the upgrade list generating unit 1900 of the right management server 1800 generates and transmits the license data upgrade list 2000 in response to the request from the user terminal 1810. However, it is not limited to this and the generation and transmission may be voluntarily performed in accordance with a rule, such as “perform every Saturday”, that is predetermined by the provider α.

Using the digital content distribution system 2 of the present invention structured as described so far, the first effect can be also achieved by the user terminal that can access the right management server at the appropriate timing in order to update the received license data. In addition, the second effect can be achieved by the right management server that can upgrade the license data transmitted to the user terminal at the appropriate timing.

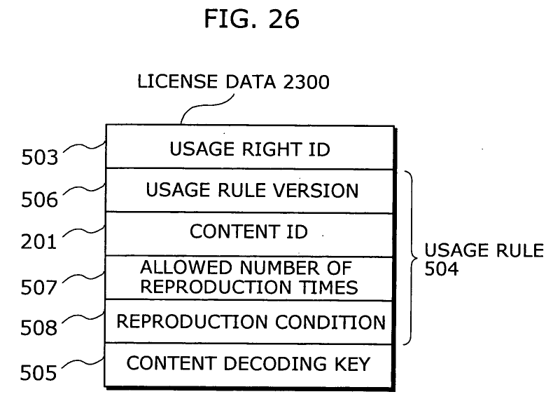

It should be noted that license data 2300 shown in FIG. 26 may be used instead of the license data 2350 of the second embodiment. This license data 2300 is different from the license data 600 of the first embodiment only in that the access condition 601 is not included. Thus, the explanation is omitted here.

### Third Embodiment

A digital content distribution system 3 of the third embodiment of the present invention is explained.

A digital content distribution system 3 of the third embodiment has almost the same structure as the digital content distribution system 2 of the second embodiment, and its operation is different only in part. On account of this, only the difference with the second embodiment will be described in the present embodiment. Also note that the common components are assigned the same numerals in the drawings of the embodiments.

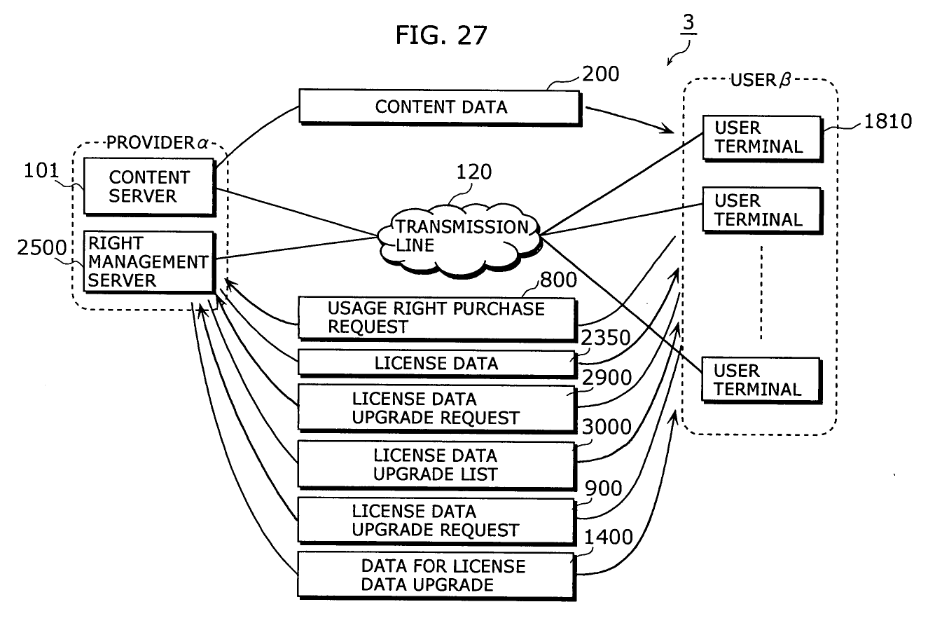

FIG. 27 is a block diagram showing an overall structure of the digital content distribution system 3 of the third embodiment.

The overall structure of the digital content distribution system 3 of the third embodiment is the same as that of the digital content distribution system 2 of the second embodiment. Therefore, the explanation is omitted here. It should be noted that a different numeral is given to a right management server 2500 in FIG. 27 than the numeral given to the right management server 1800 in FIG. 18 of the second embodiment since their internal structures are slightly different from each other.

According to the digital content distribution system 2 of the second embodiment, the user terminal 1810 transmits the license data upgrade list request 2800 made up of only the message ID to the right management server 1800, which then transmits the license data upgrade list 2000 for common use by all the user terminals to the user terminal 1810.

According to the digital content distribution system 3, on the other hand, the user terminal 1810 transmits a license data upgrade list request 2900 made up of a message ID and a terminal ID to the right management server 2500. Then, the right management server 2500 generates information specifying upgraded licenses as a license data upgrade list 3000 specifically for the user terminal 1810 that transmitted the license data upgrade list request 2900, and transmits the generated license data upgrade list 3000 to the user terminal 1810. On the basis of the license data upgrade list 3000, the user terminal 1810 issues a license data upgrade request 900 for a license that needs an upgrade. This point is substantially different from the case of the digital content distribution system 2.

Next, an explanation is given as to a structure of the right management server 2500.

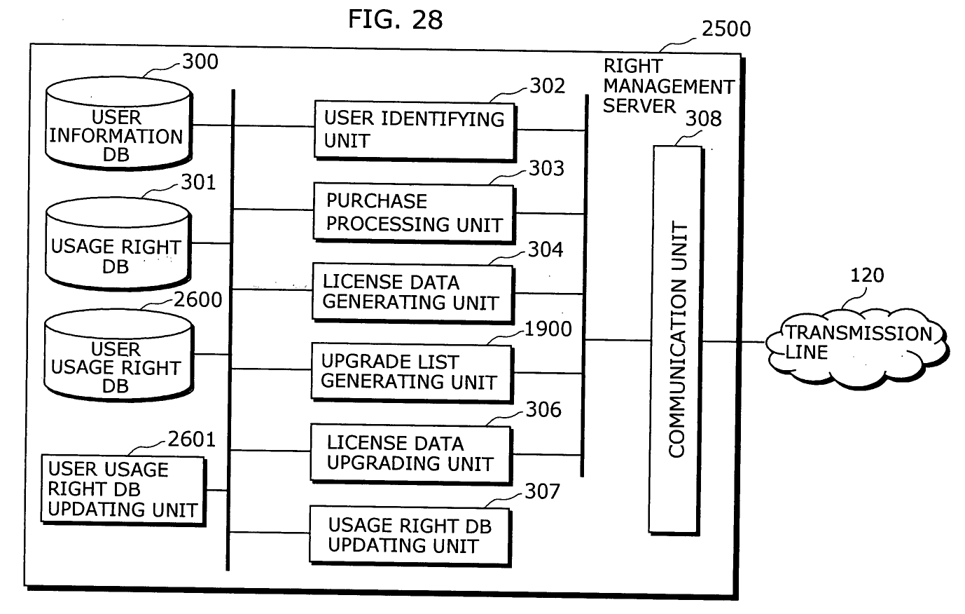

FIG. 28 is a diagram showing the structure of the right management server 2500 in the third embodiment. Note that components equivalent to those of the right management server 1800 are given the same numerals and an explanation as to them is omitted.

The right management server 2500 is different from the right management server 1800 of the second embodiment in that the server 2500 is further provided with a user usage right DB 2600 and a user usage right DB updating unit 2601 and that the upgrade list generating unit 1900 performs a different operation when generating the license data upgrade list 3000.

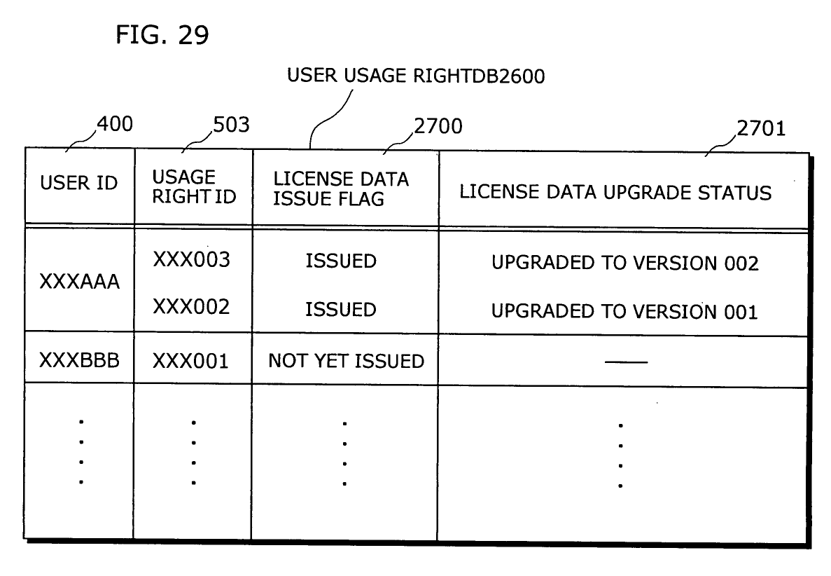

The user usage right DB 2600 manages information regarding the usage right 500 purchased by the user β. As shown in FIG. 29, this user usage right DB 2600 is made up of a user ID 400, a usage right ID 503, a license data issue flag 2700, and a license data upgrade status 2701.

The user ID 400 uniquely identifies the user β in the digital content distribution system.

The usage right ID 503 describes the usage right ID 503 of the usage right 500 purchased by the user β.

The license data issue flag 2700 describes information as to whether the license data 2350 has been issued to the user terminal 1810 owned by the user β.

The license data upgrade status 2701 shows information regarding a version to which the license data 2350 issued to the user terminal 1810 has been upgraded.

FIG. 29 shows that the user β whose user ID 400 is “xxxAAA” has purchased the usage rights 500 in which the respective usage right IDs 503 are “xxx003” and “xxx002”, for example. This diagram also shows that, as to the usage right 500 in which the usage ID 503 is “xxx003”, the license data 2350 was “issued” to the user terminal 1810 and that the usage rule version 506 of the transmitted license data 2350 is “version 002”.

The user usage right DB updating unit 2601 is used for entering and updating the details of the user usage right DB 2600. It should be noted that the data entry into the user usage right DB 2600 is performed immediately after the user β purchases a usage right (i.e., immediately after the processing performed in step S1004 in FIG. 10). Also note that the license data upgrade status 2701 of the user usage right DB 2600 is updated immediately after the data for license data upgrade 1400 is transmitted (i.e., immediately after the processing performed in step S1305 in FIG. 13).

Next, an explanation is given as to an operation performed by the upgrade list generating unit 1900 of the third embodiment to generate the license data upgrade list 3000.

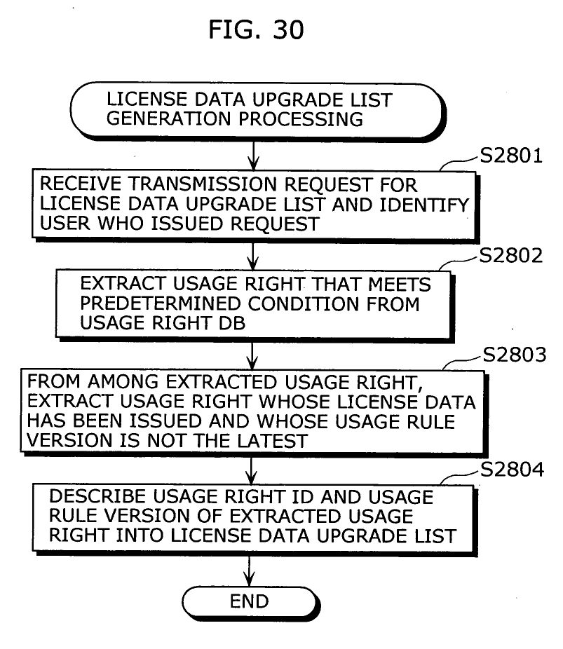

FIG. 30 is a flowchart showing an operation of license data upgrade list generation processing performed by the upgrade list generating unit 1900.

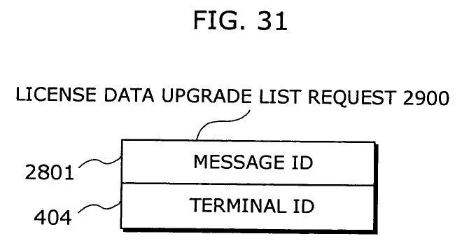

S2801: Receiving the license data upgrade list request 2900 from the user terminal 1810, the user identifying unit 302 of the right management server 2500 identifies the user β who issued the request. Note that the license data upgrade list request 2900 includes the terminal ID 404 in addition to the message ID 2801 as shown in FIG. 31.

S2802: The upgrade list generating unit 1900 references to the usage right DB 301 and extracts the usage rights 500 which meet a condition predetermined by the provider α. To be more specific, by reference to the user usage right DB 2600 using the user ID (xxxAAA, for example) identified in step S2801 as a key, the upgrade list generating unit 1900 identifies the usage right IDs (xxx003 and xxx002, for example) corresponding to that user ID and then references to the usage right DB 301 using the identified usage right ID as a key. Here, as the condition predetermined by the provider α, a condition such as “the rights updated in the past week” can be considered, for example.

S2803: The upgrade list generating unit 1900 references to the user usage right DB 2600 and the usage right DB 301. From among the usage rights 500 extracted in step S2802, the upgrade list generating unit 1900 extracts the usage right 500 whose license data 2350 has been transmitted to the user terminal 1810 owned by the user β identified in step S2801 and whose usage rule version 506 is not the latest.

For example, in a case where the above-mentioned identified user ID is “xxxAAA”, the license data issue flag 2700 indicates “issued” regarding both of the usage right IDs “xxx003” and “xxx002” according to the user usage right DB 2600. Moreover, the license data upgrade statuses 2701 corresponding to the usage right IDs “xxx003” and “xxx002” indicate “upgraded to version 002” and “upgraded to version 001” respectively. Here, if the usage rule versions 506 corresponding to the usage right IDs “xxx003” and “xxx002” of the usage right DB 301 indicate “version 002” and “version 002”, the upgrade list generating unit 1900 extracts the usage right ID “xxx002” and the usage rule version “version 002”.

S2804: The upgrade list generating unit 1900 describes the usage right ID 503 and the usage rule version 506 of the usage right 500 extracted in step S2803 as a pair into the license data upgrade list 3000.

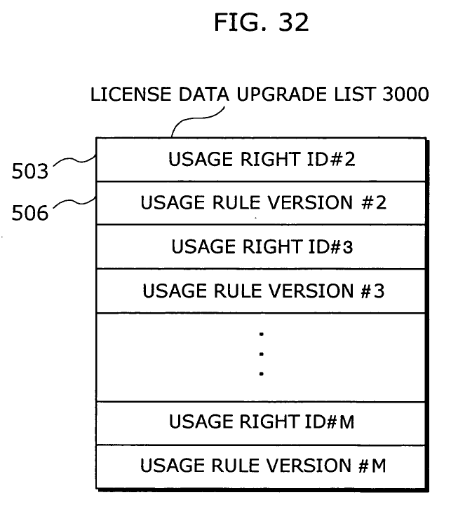

FIG. 32 is a diagram showing an example of a structure of the license data upgrade list 3000 generated by the upgrade list generating unit 1900.

Here, as shown in FIG. 32, the license data upgrade list 3000 is made up of pairs of the usage right ID 503 and the usage rule version 506. This list is data for notifying the user terminal 1810 that the usage right 500 identified by the usage right ID 503 has been upgraded to the version indicated by the usage rule version 506.

In this way, the upgrade list generating unit 1900 of the third embodiment generates a different license data upgrade list 3000 for each user.

Through the processing described so far, the upgrade list generating unit 1900 of the third embodiment generates the license data upgrade list 3000.

Accordingly, using the digital content distribution system 3 of the present invention, the first effect can be achieved by the user terminal that can access the right management server at the appropriate timing in order to update the received license data. In addition, the second effect can be achieved by the right management server that can upgrade the license data transmitted to the user terminal at the appropriate timing.

It should be noted that each set of the license data 1700, 600, 2350, and 2300 in the first, second, and third embodiments may be further made up of a signature of the right management server in association with the usage rule 504 or with the usage rule 504 and the access condition 601. To be more specific, the right management server may add its electronic signature to data in the license data that is rewritable only by the right management server itself, and may not add its signature to data that is managed by the user terminal.

In this case, the user terminal 110 may obtain a public key, verify the signature using the public key, enter it to the license data DB 702 after the verification, and transmit the license data upgrade request 900 made up of the license data including the signature to the right management server 100.

Moreover, the license data making up the data for license data upgrade 1400 may be further made up of the signature.

As shown in FIG. 9, the license data upgrade request 900 in the above first, second, and third embodiments is made up of the license data upgrade request identifier 901 and the un-upgraded license data 902 which should be upgraded. That is to say, the license data upgrade request 900 is made up of the whole license data including the content decoding key 505, etc. However, since the license data which needs to be upgraded is what should be identified, the license data upgrade request 900 may be made up of only the license data upgrade request identifier 901 and the usage right ID 503 or only the license data upgrade request identifier 901, the usage right ID 503, and the usage rule 504. With this structure, the data amount of the license data upgrade request 900 can be reduced.

As shown in FIG. 14, the data for license data upgrade 1400 of the above first, second, and third embodiments is made up of the upgraded license data 1401. That is to say, the data for license data upgrade 1400 is made up of the whole upgraded license data including the content decoding key 505, etc. However, it may be composed as follows.

The data for license data upgrade 1400 may be made up of only the usage right ID 503 and the usage rule 504. Or, the data for license data upgrade 1400 may be made up of only the usage right ID 503 and data showing rewritten details. Alternatively, the data for license data upgrade 1400 may be made up of only the usage right ID 503 and additional data. In this case, the user terminal 110 may link the additional data to the un-updated license data. Moreover, the data for license data upgrade 1400 may be made up of the usage right ID 503 and an additional license. In this case, the un-updated license data and the additional license may be linked using the usage right ID 503 as a key.

As shown in FIG. 21 and FIG. 32, each of the license data upgrade lists 2000 and 3000 of the above second and third embodiments is made up of the pairs of the usage right ID 503 and the usage rule version 506. However, it may be made up of the data for license data upgrade itself. More specifically, receiving the license data upgrade list request 2800 from the user terminal 1810, the right management server 1800 may transmit the data for license data upgrade for common use by all the user terminals to the user terminal 1810 as the object to be described in the list. Moreover, receiving the license data upgrade list request 2900 from the user terminal 1810, the right management server 2500 may transmit the data for license data upgrade specifically for that user terminal to the user terminal 1810 as the object to be described in the list.

This can omit the generation and transmission of the lists by the right management servers 1800 and 2500 and the transmission of the license data upgrade request 900 by the user terminal 1810. Thus, the user terminal 1810 can perform the update processing without delay.

In the above second and third embodiments, the user terminal 1810 pulls (Pull) the license data upgrade lists 2000 and 3000 by transmitting the license data upgrade list requests 2800 and 2900 when an instruction is received from the user or at the predetermined timing (at power-up or every Saturday, for example). However, the right management servers 1800 and 2500 may push (Push) the license data upgrade lists 2000 and 3000 at a predetermined timing, such as every Saturday.

This can also omit the generation and transmission of the license data upgrade list requests 2800 and 2900 by the user terminal 1810. Thus, the user terminal 1810 can transmit the license data upgrade request 900 without delay.

### INDUSTRIAL APPLICABILITY

The right management server of the digital content distribution system of the present invention is useful as a computer apparatus which facilitates an upgrade of the license data transmitted to the user terminal to use the content. The user terminal is useful as a computer apparatus, such as a DVD player or a personal computer, which upgrades the held license data at the appropriate timing.

1. A digital content distribution system comprising a right management server and a user terminal which are connected via a transmission line,
wherein said right management server includes:
a usage right information issuing unit operable to issue usage right information indicating a usage rule of content which is a digital copyrighted work to said user terminal; and
an update information notifying unit operable to notify said user terminal of update information regarding necessity of updating the usage right information issued to said user terminal, and
said user terminal includes:
a content storing unit operable to store the content;
a usage right information storing unit operable to store the usage right information issued by said usage right information issuing unit;
a using unit operable to use the content stored in said content storing unit in accordance with the usage rule indicated by the usage right information stored in said usage right information storing unit; and
an update requesting unit operable to request said right management server to update the usage right information stored in said usage right information storing unit, in accordance with the update information notified by said update information notifying unit.

2. The digital content distribution system according to claim 1,
wherein said update information notifying unit is operable to notify said user terminal of the update information by including the update information in the usage right information issued by said usage right information issuing unit.

3. The digital content distribution system according to claim 2,
wherein the update information includes information regarding a timing at which said user terminal should access said right management server, and
said update requesting unit is operable to access said right management server at the timing indicated by the update information and to request said right management server to update the usage right information.

4. The digital content distribution system according to claim 2,
wherein the update information includes information regarding a frequency at which said user terminal should access said right management server, and
said update requesting unit is operable to access said right management server at the frequency indicated by the update information and to request said right management server to update the usage right information.

5. The digital content distribution system according to claim 2,
wherein the update information includes a flag showing whether or not said user terminal should access said right management server, and
said update requesting unit is operable to access said right management server in accordance with the flag and to request said right management server to update the usage right information.

6. The digital content distribution system according to claim 1,
wherein the usage right information includes an identifier to identify itself, and
the update information includes the identifier of the usage right information which is an object to be updated.

7. The digital content distribution system according to claim 6, comprising a plurality of user terminals,
wherein said update information notifying unit is operable to specify, for each user terminal, the usage right information which is the object to be updated among sets of the usage right information held by said user terminal, to create the update information including the identifier of the specified usage right information, and to notify said user terminal of the created update information.

8. The digital content distribution system according to claim 6, comprising a plurality of user terminals,
wherein said update information notifying unit is operable to specify, for each user terminal, the usage right information which is the object to be updated among sets of the usage right information held by all of said plurality of user terminals, to create the update information including the identifier of the specified usage right information, and to notify said user terminal of the created update information.

9. The digital content distribution system according to claim 1,
wherein said right management server further includes
an update data transmitting unit operable to transmit, to said user terminal, data for usage right information update that is used for updating the usage right information held by said user terminal to latest usage right information when receiving a request to update the usage right information from said user terminal,
said user terminal further includes
an updating unit operable to receive the data for usage right information update that is transmitted from said right management server, to read the usage right information corresponding to the received data for usage right information update from said usage right information storing unit, and to update the read usage right information, and
said using unit is operable to use the content stored in said content storing unit in accordance with the usage rule indicated by the updated usage right information.

10. The digital content distribution system according to claim 9,
wherein the usage right information includes an identifier to identify itself,
said update requesting unit is operable to request an update by notifying said right management server of the identifier of the usage right information which is to be an object of the update, and
said update data transmitting unit is operable to transmit, to said user terminal, the data for usage right information update that is used for updating the usage right information identified by the identifier notified by said update requesting unit to the latest usage right information.

11. The digital content distribution system according to claim 10,
wherein said update requesting unit is further operable to request the update by notifying said right management server of the usage rule of the usage right information together with the identifier of the usage right information.

12. The digital content distribution system according to claim 9,
wherein said update requesting unit is operable to request an update by transmitting the usage right information which is an object of the update to said right management server, and
said update data transmitting unit is operable to transmit, to said user terminal, the data for usage right information update that is used for updating the usage right information transmitted from said update requesting unit to the latest usage right information.

13. The digital content distribution system according to claim 9,
wherein the usage right information includes an identifier to identify itself,
the data for usage right information update includes the identifier of the usage right information which is an object to be updated and data indicating details of the update, and
said updating unit is operable to update the usage right information on the basis of the identifier and the data indicating the details of the update that are included in the data for usage right information update.

14. The digital content distribution system according to claim 9,
wherein the usage right information includes an identifier to identify itself,
the data for usage right information update includes the identifier of the usage right information which is an object to be updated and information indicating an updated usage rule, and
said updating unit is operable to read, from said usage right information storing unit, the usage right information identified by the identifier included in the data for usage right information update, and to update the usage right information by replacing the usage rule of the read usage right information with the updated usage rule included in the data for usage right information update.

15. The digital content distribution system according to claim 9,
wherein the data for usage right information update includes updated usage right information, and
said updating unit is operable to read, from said usage right information storing unit, the usage right information corresponding to the updated usage right information included in the data for usage right information update, and to update the usage right information by replacing the read usage right information with the updated usage right information included in the data for usage right information update.

16. The digital content distribution system according to claim 9,
wherein the usage right information includes an identifier to identify itself,
the data for usage right information update includes the identifier of the usage right information which is an object to be updated and additional data which should be linked to the usage right information that is the object to be updated, and
said updating unit is operable to read, from said usage right information storing unit, the usage right information identified by the identifier included in the data for usage right information update, and to update the usage right information by linking the additional data to the read usage right information.

17. The digital content distribution system according to claim 9,
wherein the usage right information includes an identifier to identify itself,
the data for usage right information update includes the identifier of the usage right information which is an object to be updated and additional license information indicating a usage rule to be added, and
said updating unit is operable to read, from said usage right information storing unit, the usage right information identified by the identifier included in the data for usage right information update, and to update the usage right information by adding the usage rule indicated by the additional license information included in the data for usage right information update to the usage rule indicated by the read usage right information.

18. The digital content distribution system according to claim 9,
wherein said usage right information issuing unit is operable to affix a digital signature to the usage right information, and to transmit the usage right information together with the obtained signature text to said user terminal, and
said update data transmitting unit is operable to affix a digital signature to the data for usage right information update, and to transmit the data for usage right information update together with the obtained signature text to said user terminal.

19. The digital content distribution system according to claim 1,
wherein said update requesting unit is operable to obtain, from said right management server, data for usage right information update that is used for updating the usage right information stored in said usage right information storing unit when requesting said right management server for an update.

20. A right management server of a digital distribution system which comprises said right management server and a user terminal that are connected via a transmission line,
wherein said right management server includes:
a usage right information issuing unit operable to issue usage right information indicating a usage rule of content which is a digital copyrighted work to said user terminal;
an update information notifying unit operable to notify said user terminal of update information regarding necessity of updating the usage right information issued to said user terminal; and
an update data transmitting unit operable to transmit, to said user terminal, data for usage right information update that is used for updating the usage right information held by said user terminal to latest usage right information when receiving a request to update the usage right information from said user terminal.

21. A user terminal of a digital distribution system which comprises a right management server and said user terminal that are connected via a transmission line,
wherein said user terminal includes:
a content storing unit operable to store content which is a digital copyrighted work;
a usage right information storing unit operable to store usage right information issued by said right management server;
a using unit operable to use the content stored in said content storing unit in accordance with a usage rule indicated by the usage right information stored in said usage right information storing unit;
an update requesting unit operable to request said right management server to update the usage right information stored in said usage right information storing unit, in accordance with update information notified by said right management server; and
an updating unit operable to receive data for usage right information update that is transmitted from said right management server, to read the usage right information corresponding to the received data for usage right information update from said usage right information storing unit, and to update the read usage right information, and
said using unit is operable to use the content stored in said content storing unit in accordance with a usage rule indicated by the updated usage right information.

22. A right management method used by a digital content distribution system comprising a right management server and a user terminal which are connected via a transmission line, said right management method comprising:
a usage right information issuing step of issuing usage right information indicating a usage rule of content which is a digital copyrighted work to the user terminal;
an update information notifying step of notifying the user terminal of update information regarding necessity of updating the usage right information issued to the user terminal; and
an update data transmitting step of transmitting, to the user terminal, data for usage right information update that is used for updating the usage right information held by the user terminal to latest usage right information when receiving a request to update the usage right information from the user terminal.

23. A content usage method used by a digital content distribution system comprising a right management server and a user terminal which are connected via a transmission line, said content usage method comprising:
a usage right information obtaining step of obtaining usage right information issued by the right management server;
a using step of using content which is a digital copyrighted work, in accordance with a usage rule indicated by the obtained usage right information;
an update requesting step of requesting the right management server to update the usage right information, in accordance with update information notified by the right management server; and
an updating step of receiving data for usage right information update that is transmitted from the right management server and of updating the usage right information corresponding to the received data for usage right information update,
wherein in said using step, the content is used in accordance with a usage rule indicated by the updated usage right information.

24. A program for a right management server of a digital content distribution system comprising said right management server and a user terminal which are connected via a transmission line, said program causing a computer to execute said steps of the right management method described in claim 22.

25. A program for a user terminal of a digital content distribution system comprising a right management server and said user terminal which are connected via a transmission line, said program causing a computer to execute said steps of the content usage method described in claim 23.
